(19) United States
(12) Patent Application Publication
(10) Pub. No.: US 2025/0105654 A1
(43) Pub. Date: Mar. 27, 2025

(54) HIGH VOLTAGE DIRECT-MOUNTED ENERGY STORAGE METHOD AND SYSTEM FOR ELIMINATING FREQUENCY MULTIPLYING CURRENT IN BATTERY CHARGE AND DISCHARGE

(71) Applicant: SHANGHAI ZHONGLV NEW ENERGY TECHNOLOGY CO., LTD., Shanghai (CN)

(72) Inventors: Xu CAI, Shanghai (CN); Xianqiang SHI, Shanghai (CN); Chen ZHANG, Shanghai (CN); Chang LIU, Shanghai (CN); Rui LI, Shanghai (CN); Renxin YANG, Shanghai (CN); Xiqi WU, Shanghai (CN); Han WANG, Shanghai (CN)

(73) Assignee: SHANGHAI ZHONGLV NEW ENERGY TECHNOLOGY CO., LTD., Shanghai (CN)

(21) Appl. No.: 18/832,125

(22) PCT Filed: Oct. 10, 2022
(86) PCT No.: PCT/CN2022/124270

§ 371 Date: Jul. 23, 2024

(30) Foreign Application Priority Data
Jan. 25, 2022 (CN) 202210085956.0

(51) Int. Cl. H02J 7/04; H02J 7/00

(52) U.S. Cl. CPC H02J 7/04; H02J 7/00711; H02J 2207/10; H02J 2207/20

(57) ABSTRACT

A high voltage direct-mounted energy storage method and system for eliminating a frequency multiplying current in battery charge and discharge is provided. The method includes: a single star type connected high voltage direct-mounted energy storage power conversion step: injecting a set frequency-tripling common mode voltage into a modulating voltage of a bridge arm of a converter, improving a harmonic number in a direct current bus current of a power module from double frequency to quadruplicated frequency, and directly superposing the set frequency-tripling common mode voltage into the modulating voltage; and a single angle type connected high voltage direct-mounted energy storage power conversion step: injecting the set frequency-tripling common mode current into the bridge arm, improving the harmonic number from double frequency to quadruplicated frequency, and calculating a required frequency-tripling common mode voltage according to the set frequency-tripling common mode current and superposing it into the modulating voltage.

### CROSS REFERENCE TO THE RELATED APPLICATIONS

This application is the national phase entry of International Application No. PCT/CN2022/124270, filed on Oct. 10, 2022, which is based upon and claims priority to Chinese Patent Application No. 202210085956.0, filed on Jan. 25, 2022, the entire contents of which are incorporated herein by reference.

### TECHNICAL FIELD

The present invention relates to the technical field of electric automation equipment, and particularly relates to a high voltage direct-mounted energy storage method and system for eliminating a frequency multiplying current in battery charge and discharge.

### BACKGROUND

In recent years, new energy power generation represented by wind power and photovoltaic power has increased continuously and rapidly, such that a power supply structure in a power system has changed profoundly. With increase of the ratio of renewable energy sources, problems such as consumption, transmission and distribution and fluctuation in the power system appear. Rigid demands on energy storage have been formed already and become a key technology of power production consumption mode and energy structure transformation in the future.

In a high voltage direct-mounted energy storage power conversion system, battery clusters are directly connected to a direct current bus of a cascaded bridge H converter dispersively without other power conversion devices therebetween. Since the current of the direct current bus of the bridge H converter contains a secondary harmonic component, there is a secondary harmonic current with a large amplitude in the current flowing through the battery. On the one hand, the harmonic current will affect the life of the battery and the efficiency of the system. On the other hand, the harmonic current will affect will affect estimation of the SOC of the battery, which harms the safety of the battery. The harmonic current in battery charge and discharge is one of critical factors that restrict development of high voltage direct-mounted energy storage. Therefore, it is necessary to control the harmonic currents of this kind of conversion devices at fewer values.

The simplest method to reduce the harmonic amplitude is to connect a passive filter between the bridge H converter and the battery cluster, which, however, will increase the volume of the system, thus, not facilitating improvement of the power density of the converter. The method of additionally arranging a DC/DC bidirectional converter on the direct current bus can achieve an effect of inhibiting a pulsating current with a smaller filter, which, however, increases the system cost and the complexity, thus, not facilitating improvement of reliability. Therefore, a method completely eliminating the low frequency harmonic current or improving the harmonic number from low frequency to high frequency is needed to reduce the influence of the harmonic current on the life of the battery and the power density of the system. Therefore, it is an urgent need for an improved technology to solve the problem existing in the prior art.

### SUMMARY

To overcome defects in the prior art, embodiments of the present invention provide a high voltage direct-mounted energy storage method and system for eliminating a frequency multiplying current in battery charge and discharge.

According to the high voltage direct-mounted energy storage method and system for eliminating a frequency multiplying current in battery charge and discharge provided by the embodiments of the present invention, the solution is as follows:
in a first aspect, provided is a high voltage direct-mounted energy storage method for eliminating a frequency multiplying current in battery charge and discharge, including:
a single star type connected high voltage direct-mounted energy storage power conversion step: injecting a set frequency-tripling common mode voltage into a modulating voltage of a bridge arm of a converter, improving a harmonic number in a direct current bus current of a power module from double frequency to quadruplicated frequency, and directly superposing the set frequency-tripling common mode voltage into the modulating voltage of the bridge arm; and
a single angle type connected high voltage direct-mounted energy storage power conversion step: injecting a set frequency-tripling common mode current into the bridge arm of the converter, improving the harmonic number in the direct current bus current of the power module from double frequency to quadruplicated frequency, and calculating a required frequency-tripling common mode voltage according to the set frequency-tripling common mode current and superposing the required frequency-tripling common mode voltage into the modulating voltage of the bridge arm; and
targeted at a harmonic component of an additional frequency-quadruplicating current after a frequency-tripling common mode electric quantity is injected, and continuously injecting a corresponding frequency-quintupling common mode electric quantity to improve the frequency-quintupling common mode electric quantity to a hexaplicating frequency to completely eliminate all frequency-multiplying currents in the direct current bus current of the power module by parity of reasoning.

Further, the single star type connected high voltage direct-mounted energy storage power conversion step includes: completely eliminating the frequency-doubling harmonic component in the direct current bus current of the power module by superposing the set frequency-tripling common mode voltage into the modulating voltage of the bridge arm of the converter, specifically as follows:
a voltage of a power grid of an alternating current side is:

$$\{ \begin{matrix}{u}_{sa} = {U}_{m} cos ( ω t ) \\ {u}_{sb} = {U}_{m} cos ( ω t - \frac{2}{3} π ) \\ {u}_{sc} = {U}_{m} cos ( ω t + \frac{2}{3} π )\end{matrix}$$

where uₛₓ represents a three-phase voltage of the power grid, subscript x=a, b, c respectively represents phases A, B, and C; Uₘ represents an amplitude of the voltage of the power grid; @ represents an angular frequency of the power grid; and t represents time.

Preferably, in the single star type connected high voltage direct-mounted energy storage power conversion step, after the frequency-tripling common mode voltage is injected, the modulating voltage of the phase-A bridge arm is re-written as:

$${u}_{aref} = {U}_{vm 1} cos ( ω t + {δ}_{1} ) - {U}_{vm 1} cos ( 3 ω t + {δ}_{1} - 2 {φ}_{1} )$$

where φ₁ represents a phase angle difference between the output current of the alternating current side and the voltage of the power grid, Uᵥₘ₁ represents an amplitude of a fundamental frequency modulating voltage of the bridge arm, and δ₁ represents a phase angle difference between the modulating voltage and the voltage of the power grid;
in a case that (1=±π/2, the modulating voltage of the phase-A bridge arm is:

$${u}_{aref} = {U}_{vm 1} cos ( ω t ) + {U}_{vm 1} cos ( 3 ω t )$$

in a case that ωt=0, a maximum value of the amplitude of the modulating voltage of the bridge arm in all working conditions is obtained as follows:

$${( {u}_{aref} )}_{max} = 2 {U}_{vm 1} \approx 2 {U}_{m}$$

for the single star type connected high voltage direct-mounted energy storage power conversion system, the maximum amplitude of the modulating voltage after the frequency-tripling common mode voltage is injected is as twice as the amplitude of the voltage of the power grid.

Further, in the single star type connected high voltage direct-mounted energy storage power conversion step, a capacity of a battery cluster of the power module is set as I_{bat}, and in a case that the energy storage power conversion system with a rated capacity of S is constructed, a following equation is satisfied:

$${I}_{bat} = \frac{S}{3 {NU}_{dc}}$$

where U_{dc} represents a rated direct current voltage of the battery cluster, and N represents a number of power modules contained in each bridge arm;
the maximum value of I_{bat} obtained on the market is set as Iₗᵢₘ, if the following equation is satisfied:

$$\frac{S}{3 {NU}_{dc}} \leq {I}_{lim}$$

in a case that the frequency-tripling common mode voltage is injected, the number of power modules contained in the bridge arm per phase is designed as:

$$N = \frac{2 {U}_{m}}{{MU}_{dc}}$$

where M represents a modulating ratio of the power conversion system, the modulating ratio being usually selected as follows: 0.7<M<0.9;
in a case that Iₗᵢₘ satisfies the following equation:

$${I}_{lim} > \frac{S}{3 {NU}_{dc}}$$

the number of power modules contained in the bridge arm per phase is designed as:

$$N = \frac{S}{3 {i}_{lim} {U}_{dc}}$$

Further, the single star type connected high voltage direct-mounted energy storage power conversion step includes:
achieving complete elimination of the frequency-doubling harmonic wave by superposing the set frequency-tripling common mode voltage into the modulating voltage of the bridge arm per phase by the following steps:
first, extracting components i_{d} and i_{q} of axes d and q of an output current of the alternating current side of the power conversion system and components u_{dref0} and u_{qref0} of the axes d and q of a modulating voltage thereof, and calculating an amplitude Iᵥₘ₁ of the output current of the alternating current side and an amplitude Uᵥₘ₁ of the modulating voltage of the bridge arm according to the following equations:

$$\{ \begin{matrix}{I}_{vm 1} = \sqrt{{i}_{d}^{2} + {i}_{q}^{2}} \\ {U}_{vm 1} = \sqrt{{u}_{dref 0}^{2} + {u}_{qref 0}^{2}}\end{matrix}$$

second, calculating values of phase angles θ₁ and φ₁, respectively being:

$$\{ \begin{matrix}{δ}_{1} = {tan}^{- 1} ( \frac{{u}_{qref 0}}{{u}_{dref 0}} ) \\ {φ}_{1} = - {tan}^{- 1} ( \frac{{i}_{q}}{{i}_{d}} )\end{matrix}$$

finally, obtaining the modulating voltage of a three-phase bridge arm:

$$\{ \begin{matrix}{u}_{aref} = {u}_{dref 0} cos ( {θ}_{p} ) - {u}_{qref 0} sin ( {θ}_{p} ) - {U}_{vm 1} cos ( 3 {θ}_{p} + {δ}_{1} - 2 {φ}_{1} ) \\ {u}_{bref} = {u}_{dref 0} cos ( {θ}_{p} - \frac{2}{3} π ) - {u}_{qref 0} sin ( {θ}_{p} - \frac{2}{3} π ) - {U}_{vm 1} cos ( 3 {θ}_{p} + {δ}_{1} - 2 {φ}_{1} ) \\ {u}_{cref} = {u}_{dref 0} cos ( {θ}_{p} + \frac{2}{3} π ) - {u}_{qref 0} sin ( {θ}_{p} + \frac{2}{3} π ) - {U}_{vm 1} cos ( 3 {θ}_{p} + {δ}_{1} - 2 {φ}_{1} )\end{matrix}$$

where u_{xref} represents the modulating voltage of the three-phase bridge arm after the frequency-tripling common mode voltage is injected, subscripts x=a, b, c respectively represent phases A, B, and C, and θₚ represents an angle of an output of a phase-locked loop.

Further, the single angle type connected high voltage direct-mounted energy storage power conversion step includes: completely eliminating the frequency-doubling harmonic component in the direct current bus current of the power module by injecting the set frequency-tripling common mode current into the bridge arm of the converter, obtaining the corresponding frequency-tripling common mode voltage according to the set frequency-tripling common mode current and superposing the required frequency-tripling common mode voltage into the modulating voltage of the bridge arm, specifically as follows:
the voltage of the power grid of the alternating current side is written as:

$$\{ \begin{matrix}{u}_{sa} = {U}_{m} cos ( ω t ) \\ {u}_{sb} = {U}_{m} cos ( ω t - \frac{2}{3} π ) \\ {u}_{sc} = {U}_{m} cos ( ω t + \frac{2}{3} π )\end{matrix}$$

where uₛₓ represents a three-phase voltage of the power grid, subscript x=a, b, c respectively represents phases A, B, and C; Uₘ represents an amplitude of the voltage of the power grid; and ω represents an angular frequency of the power grid;
an output current of a three-phase alternating current side is:

$$\{ \begin{matrix}{i}_{a} = {I}_{vm 1} cos ( ω t - {φ}_{1} ) \\ {i}_{b} = {I}_{vm 1} cos ( ω t - {φ}_{1} - \frac{2}{3} π ) \\ {i}_{c} = {I}_{vm 1} cos ( ω t - {φ}_{1} + \frac{2}{3} π )\end{matrix}$$

where iₓ represents the output current of the alternating current side of the power conversion system, subscripts x=a, b, c respectively represent phases A, B, and C, Iᵥₘ₁ represents an amplitude of the current of the alternating current side, and φ₁ represents a phase angle difference between the output current of the alternating current side and the voltage of the power grid;
Further, in the single angle type connected high voltage direct-mounted energy storage power conversion step, to eliminate the frequency-doubling harmonic current, the corresponding frequency-tripling common mode voltage is obtained according to the set frequency-tripling common mode current and the frequency-tripling common mode voltage is superposed into the modulating voltage of the bridge arm, wherein the frequency-tripling common mode voltage is obtained by a product of the frequency-tripling common mode current and reactance of the bridge arm, an implementation method including the following steps:
first, extracting components i_{d} and i_{q} of axes d and q of the output current of the alternating current side of the power conversion system and components u_{dref0} and u_{qref0} of the axes d and q of a modulating voltage thereof, and calculating the amplitude Iᵥₘ₁ of the output current of the alternating current side according to the following equation:

$${I}_{vm 1} = \sqrt{{i}_{d}^{2} + {i}_{q}^{2}}$$

second, calculating values of phase angles δ₁ and φ₁, respectively being:

$$\{ \begin{matrix}{δ}_{1} = {tan}^{- 1} ( \frac{{u}_{qref 0}}{{u}_{dref 0}} ) \\ {φ}_{1} = - {tan}^{- 1} ( \frac{{i}_{q}}{{i}_{d}} )\end{matrix}$$

controlling a fundamental frequency component in a current of the phase bridge arm by the fundamental frequency modulating voltage thereof, and obtaining the frequency-tripling component in the current of the phase bridge arm by superposing the frequency-tripling modulating voltage into the fundamental frequency modulating voltage of the phase bridge arm;
calculating the modulating voltage of the three-phase alternating current side by the following equation:

$$\{ \begin{matrix}{u}_{aref 0} = {u}_{dref 0} cos ( {θ}_{p} ) - {u}_{qref 0} sin ( {θ}_{p} ) \\ {u}_{bref 0} = {u}_{dref 0} cos ( {θ}_{p} - \frac{2}{3} π ) - {u}_{qref 0} sin ( {θ}_{p} - \frac{2}{3} π ) \\ {u}_{cref 0} = {u}_{dref 0} cos ( {θ}_{p} + \frac{2}{3} π ) - {u}_{qref 0} sin ( {θ}_{p} + \frac{2}{3} π )\end{matrix}$$

obtaining the final modulating voltage of the three-phase bridge arm by the following equation:

$$\{ \begin{matrix}{u}_{aaref} = {u}_{aref 0} - {u}_{cref 0} - \frac{2 \sqrt{3}}{3} ω {LI}_{vm 1} cos ( 3 {θ}_{p} + 2 {δ}_{1} - {φ}_{1} ) \\ {u}_{obref} = {u}_{bref 0} - {u}_{aref 0} - \frac{2 \sqrt{3}}{3} ω {LI}_{vm 1} cos ( 3 {θ}_{p} + 2 {δ}_{1} - {φ}_{1} ) \\ {u}_{acref} = {u}_{cref 0} - {u}_{bref 0} - \frac{2 \sqrt{3}}{3} ω {LI}_{vm 1} cos ( 3 {θ}_{p} + 2 {δ}_{1} - {φ}_{1} )\end{matrix}$$

where L is inductance of the phase bridge arm, and Op represents an angle of the output of the phase-locked loop.

Further, in the single angle type connected high voltage direct-mounted energy storage power conversion step, to eliminate the frequency-doubling harmonic current, the corresponding frequency-tripling common mode voltage is obtained according to the set frequency-tripling common mode current and the frequency-tripling common mode voltage is superposed into the modulating voltage of the bridge arm, where the frequency-tripling common mode voltage can be further obtained by performing closed-loop control based on a proportional-integral regulator, an implementation method including the following steps:
1) extracting current values of three bridge arms in the single angle type connected high voltage direct-mounted energy storage power conversion step, and calculating the frequency-tripling common mode current i_{z} in real time according to the collected current values, a calculation method being as follows: i_{z}=(iₐₐ+i_{ab}+i_{ac})/3, where iₐₐ, i_{ab}, and i_{ac} respectively represent the currents in the phase-A bridge arm, the phase-B bridge arm, and the phase-C bridge arm;
2) outputting i_{z} by delaying the same at 90°, i.e., delaying T/4 time to obtain i_{zβ}, where i_{zβ} represents a virtual axis β component of the frequency-tripling common mode current obtained by delaying the frequency-tripling common mode current by T/4 time;
3) calculating components i_{zd} and i_{zq} of axes d and q of a virtual current vector of i_{z} in a synchronous rotating reference frame by the following method:

$$\{ \begin{matrix}{i}_{zd} = {i}_{z} cos ( 3 {θ}_{p} ) - {i}_{z β} sin ( 3 {θ}_{p} ) \\ {i}_{zq} = - {i}_{z β} cos ( 3 {θ}_{p} ) - {i}_{z} sin ( 3 {θ}_{p} )\end{matrix}$$

where θp represents the angle of the output of the phase-locked loop;
4) extracting the components i_{d} and i_{q} of axes d and q of the output current of the alternating current side of the power conversion system and components u_{dref0} and u_{qref0} of the axes d and q of a modulating voltage thereof, and calculating the amplitude Iᵥₘ₁ of the output current of the alternating current side according to the following equation:

$${I}_{vm 1} = \sqrt{{i}_{d}^{2} + {i}_{q}^{2}}$$

5) calculating the values of the phase angles δ₁ and φ₁, respectively being:

$$\{ \begin{matrix}{δ}_{1} = {tan}^{- 1} ( \frac{{u}_{qref 0}}{{u}_{dref 0}} ) \\ {φ}_{1} = - {tan}^{- 1} ( \frac{{i}_{q}}{{i}_{d}} )\end{matrix}$$

6) performing differential comparison on i_{zd} and i_{zq} and a reference value,

$$\{ \begin{matrix}{i}_{zdref} = - \frac{\sqrt{3}}{3} {I}_{vm 1} sin ( 2 {δ}_{1} - {φ}_{1} ) \\ {i}_{zqref} = \frac{\sqrt{3}}{3} {I}_{vm 1} cos ( 2 {δ}_{1} - {φ}_{1} )\end{matrix}$$

and feeding a difference to a PI regulator;
7) importing 3ωLi_{zq} and 3ωLi_{zd} on outputs of the respective PI regulators to eliminate a coupled portion of the axes d and q to obtain reference voltages of the axes d and q of the frequency-tripling common mode current, respectively marked as u_{zdref} and u_{zqref},
8) obtaining the modulating voltage of the three-phase alternating current side by the following equation:

$$\{ \begin{matrix}{u}_{aref 0} = {u}_{dref 0} cos ( {θ}_{p} ) - {u}_{qref 0} sin ( {θ}_{p} ) \\ {u}_{bref 0} = {u}_{dref 0} cos ( {θ}_{p} - \frac{2}{3} π ) - {u}_{qref 0} sin ( {θ}_{p} - \frac{2}{3} π ) \\ {u}_{cref 0} = {u}_{dref 0} cos ( {θ}_{p} + \frac{2}{3} π ) - {u}_{qref 0} sin ( {θ}_{p} + \frac{2}{3} π )\end{matrix}$$

and 9) obtaining the final modulating voltage of the three-phase bridge arm by the following equation:

$$\{ \begin{matrix}{u}_{aaref} = {u}_{aref 0} - {u}_{cref 0} - [ {u}_{zdref} cos ( 3 {θ}_{p} ) - {u}_{zqref} sin ( 3 {θ}_{p} ) ] \\ {u}_{abref} = {u}_{bref 0} - {u}_{aref 0} - [ {u}_{zdref} cos ( 3 {θ}_{p} ) - {u}_{zqref} sin ( 3 {θ}_{p} ) ] \\ {u}_{acref} = {u}_{cref 0} - {u}_{bref 0} - [ {u}_{zdref} cos ( 3 {θ}_{p} ) - {u}_{zqref} sin ( 3 {θ}_{p} ) ]\end{matrix} .$$

Further, in the single angle type connected high voltage direct-mounted energy storage power conversion step, after the frequency-tripling common mode voltage is injected, the current of the bridge arm of the phase-A bridge arm is:

$${i}_{aa} = \frac{\sqrt{3}}{3} {I}_{vm 1} [ cos ( ω t - {φ}_{1} + \frac{5 π}{6} ) - cos ( 3 ω t + 2 {δ}_{1} - {φ}_{1} + \frac{1}{2} π ) ]$$

in a case that φ₁=±π/2, the current of the bridge arm of the phase A is:

$${i}_{aa} = \frac{\sqrt{3}}{3} {I}_{vm 1} [ cos ( ω t - {φ}_{1} + \frac{5 π}{6} ) - cos ( 3 ω t + 2 {δ}_{1} - {φ}_{1} + \frac{1}{2} π ) ]$$

in a case that ωt=⅔π, a maximum value of the current of the bridge arm of the phase A in all working conditions is obtained as follows:

$${( {i}_{aa} )}_{max} = \frac{2 \sqrt{3}}{3} {I}_{vm 1}$$

for the single angle type connected high voltage direct-mounted energy storage power conversion system, the maximum amplitude of the current of the bridge arm after the frequency-tripling common mode current is injected is 1.15 times of the amplitude of the output current of the alternating current side of the system;
for the single angle type connected high voltage direct-mounted energy storage power conversion step, in a case that the energy storage power conversion system with the rated capacity of S is constructed, the following equation is satisfied:

$${I}_{vm 1} = \frac{S}{1.5 {U}_{vm 1}}$$

after the frequency-tripling common mode current is injected, in a case that a switching element of the high voltage direct-mounted energy storage power conversion system is subjected to model selection, if a 0.5-1 time of a current margin is considered, a current grade of the switching element shall be selected as follows:

$${I}_{PT} = ( 1.73 ∼ 2.31 ) {I}_{vm 1} .$$

where I_{PT} represents current rating of the switching element of the high voltage direct-mounted energy storage power conversion system.

In a second aspect, provided is a high voltage direct-mounted energy storage system for eliminating a frequency multiplying current in battery charge and discharge, including:
a single star type connected high voltage direct-mounted energy storage power conversion module, configured to inject a set frequency-tripling common mode voltage into a modulating voltage of a bridge arm of a converter, improve a harmonic number in a direct current bus current of a power module from double frequency to quadruplicated frequency, and directly superpose the set frequency-tripling common mode voltage into the modulating voltage of the bridge arm; and
a single angle type connected high voltage direct-mounted energy storage power conversion module, configured to inject the set frequency-tripling common mode current into the bridge arm of the converter, improve the harmonic number in the direct current bus current of the power module from double frequency to quadruplicated frequency, calculate a required frequency-tripling common mode voltage according to the set frequency-tripling common mode current and superpose the required frequency-tripling common mode voltage into the modulating voltage of the bridge arm; and
targeted at a harmonic component of an additional frequency-quadruplicating current after a frequency-tripling common mode electric quantity is injected, and continuously injecting a corresponding frequency-quintupling common mode electric quantity to improve the frequency-quintupling common mode electric quantity to a hexaplicating frequency to completely eliminate all frequency-multiplying currents in the direct current bus current of the power module by parity of reasoning.

### BRIEF DESCRIPTION OF THE DRAWINGS

By reading and referring to detailed description made by the following drawings to non-restrictive embodiments, other features, purposes and advantages of the present invention will become more obvious:

FIG. 1 is a schematic diagram of a topological structure of a single star type high voltage direct-mounted energy storage power conversion system in one of embodiments of the present invention;

FIG. 2 is a schematic diagram of a control structure of the single star type high voltage direct-mounted energy storage power conversion system in one of embodiments of the present invention;

FIG. 3 is a schematic diagram of a topological structure of a single angle type high voltage direct-mounted energy storage power conversion system in one of embodiments of the present invention;

FIG. 4 is a schematic diagram of a control structure of the single angle type high voltage direct-mounted energy storage power conversion system in one of embodiments of the present invention (a frequency-tripling common mode voltage is calculated based on reactance of a bridge arm);

FIG. 5 is a schematic diagram of a control structure of the single angle type high voltage direct-mounted energy storage power conversion system in one of embodiments of the present invention (the frequency-tripling common mode voltage is calculated based on an PI regulator);

FIG. 6 is a schematic diagram of a topological structure of a double star type high voltage direct-mounted energy storage power conversion system in one of embodiments of the present invention;

FIG. 7 is a schematic diagram of a topological structure of a hybrid high voltage direct-mounted energy storage power conversion system formed by connecting M single star type high voltage direct-mounted energy storage power conversion systems in parallel on an alternating current side through inductors in one of embodiments of the present invention;

FIG. 8 is a schematic diagram of a topological structure of a hybrid high voltage direct-mounted energy storage power conversion system formed by connecting M single angle type high voltage direct-mounted energy storage power conversion systems in parallel on an alternating current side through inductors in one of embodiments of the present invention;

FIG. 9 is a schematic diagram of a topological structure of a hybrid high voltage direct-mounted energy storage power conversion system formed by connecting M1 single star type high voltage direct-mounted energy storage power conversion systems and M2 single angle type high voltage direct-mounted energy storage power conversion systems in parallel on the alternating current side through inductors in one of embodiments of the present invention;

FIG. 10 is a simulation result of the single star type connected high voltage direct-mounted energy storage power conversion system without injecting the frequency-tripling common mode voltage in one of embodiments of the present invention;

FIG. 11 is a simulation result of the single star type connected high voltage direct-mounted energy storage power conversion system without injecting the frequency-tripling common mode voltage in one of embodiments of the present invention; and

FIG. 12 is a simulation result of the single angle type connected high voltage direct-mounted energy storage power conversion system without injecting the frequency-tripling common mode current in one of embodiments of the present invention.

### DETAILED DESCRIPTION OF THE EMBODIMENTS

The present invention will be described in detail below in combination with specific embodiments. The embodiments below contribute to further understanding the present invention by those skilled in the art but do not limit the present invention in any form. It should be noted that variations and improvements still can be made by those skilled in the technical field without departing the concept of the present invention. The variations and improvements all fall within the scope of the protection of the present invention.

Embodiments of the present invention provide a high voltage direct-mounted energy storage method for eliminating a frequency multiplying current in battery charge and discharge, including two basic power conversion units: a single star type connected high voltage direct-mounted energy storage power conversion step and a single angle type connected high voltage direct-mounted energy storage power conversion step. The two basic power units each include bridge H sub modules, with frequency-doubling harmonic currents on direct current sides thereof. On the one hand, the harmonic current will affect the life of the battery and the efficiency of the system. On the other hand, the harmonic current will affect will affect estimation of the SOC of the battery, which harms the safety of the battery. The inhibit the harmonic current, usually, a passive filter is connected in series between a bridge H converter and a batter cluster or a DC/DC bidirectional converter is additionally arranged therebetween, which, however, will increase the volume and the control complexity of the system. Therefore, the harmonic current in battery charge and discharge is one of critical factors that restrict development of high voltage direct-mounted energy storage.

Referring to FIG. 1, it is the schematic diagram of a topological structure of a single star type connected high voltage direct-mounted energy storage power conversion system provided by the present invention, where uₛₓ is a three-phase voltage of a power grid (subscripts x=a, b, c respectively represent phases A, B, and C); L_{ac} is filter inductance of an alternating current side; PM_{xy} is a y^{th} cascaded power module of a phase x (y=1, 2 . . . . N); N is a number of power modules contained in the bridge arm per phase; ix is an output current of the alternating current side; uₓ is an output voltage of the three-phase bridge arm; ide is a current of a direct current bus of the power module; and an LC filter in the power module can be L-shaped, T-shaped and π-shaped low pass filter or a harmonic filter formed by connecting an inductor and a capacitor to a harmonic circuit in series and in parallel.

The single star type connected high voltage direct-mounted energy storage power conversion step includes: injecting a set frequency-tripling common mode voltage into a modulating voltage of a bridge arm of a converter, improving a harmonic number in a direct current bus current of a power module from double frequency to quadruplicated frequency, and directly superposing the set frequency-tripling common mode voltage into the modulating voltage of the bridge arm; and
the single angle type connected high voltage direct-mounted energy storage power conversion step includes: injecting a set frequency-tripling common mode current into the bridge arm of the converter, improving the harmonic number in the direct current bus current of the power module from double frequency to quadruplicated frequency, and calculating a required frequency-tripling common mode voltage according to the set frequency-tripling common mode current and superposing the required frequency-tripling common mode voltage into the modulating voltage of the bridge arm; and
for the single star type connected high voltage direct-mounted energy storage power conversion step, compared with no frequency-tripling common mode voltage injected, the amplitude of the modulating voltage of the converter after the frequency-tripling common mode voltage is injected will change, and in this case, it is needed to redesign the number of the power modules in the bridge arm; similarly, for the single angle type connected high voltage direct-mounted energy storage power conversion step, compared with no frequency-tripling common mode voltage injected, the amplitude of the current of the bridge arm of the converter after the frequency-tripling common mode voltage is injected will change, and in this case, it is needed to redesign the current rating of a power device of the power module in the bridge arm;
targeted at a harmonic component of an additional frequency-quadruplicating current after a frequency-tripling common mode electric quantity is injected, and continuously injecting a corresponding frequency-quintupling common mode electric quantity to improve the frequency-quintupling common mode electric quantity to a hexaplicating frequency to completely eliminate all frequency-multiplying currents in the direct current bus current of the power module by parity of reasoning.

The single star type connected high voltage direct-mounted energy storage power conversion step and the single angle type connected high voltage direct-mounted energy storage power conversion step can form a hybrid energy storage power conversion system as the basic power conversion units respectively, and then each of the basic power units can eliminate the frequency multiplying current in the direct current bus of each power module by adopting a common mode electric quantity injection method applicable to the unit.

After the harmonic number in the current of the direct current bus of the power module from double frequency to multiplicated frequency, on the one hand, under a condition of the same amplitude of the harmonic current, the requirement of the power module on the passive filter can be reduced greatly, and therefore, the power density of the whole power conversion system is improved. On the other hand, in a case that the same passive filter is used, the amplitude of the harmonic current can be reduced greatly, so that the service life of the battery is prolonged.

For the single star type connected high voltage direct-mounted energy storage power conversion step, the completely eliminating the frequency-doubling harmonic component in the direct current bus current of the power module by superposing the set frequency-tripling common mode voltage into the modulating voltage of the bridge arm of the converter specifically includes:
a voltage of a power grid of an alternating current side is:

$$\{ \begin{matrix}{u}_{sa} = {U}_{m} cos ( ω t ) \\ {u}_{sb} = {U}_{m} cos ( ω t - \frac{2}{3} π ) \\ {u}_{sc} = {U}_{m} cos ( ω t + \frac{2}{3} π )\end{matrix}$$

where uₛₓ represents a three-phase voltage of the power grid, subscript x=a, b, c respectively represents phases A, B, and C; Uₘ represents an amplitude of the voltage of the power grid; w represents an angular frequency of the power grid; and t represents time.

Analyzed by taking the phase A as an example, assuming that an output current of the alternating current side thereof is:

$${i}_{a} = {I}_{vm 1} cos ( ω t - {φ}_{1} )$$

where iₐ represents an output current of a phase A alternating current side, Iᵥₘ₁ represents an amplitude of the current, and φ₁ represents a phase angle difference between the current and the voltage of the power grid.

In a case that the frequency-tripling common mode voltage is not injected, it is assumed that the modulating voltage of the phase-A bridge arm is:

$${u}_{aref 0} = {U}_{vm 1} cos ( ω t + {δ}_{1} )$$

where u_{aref0} represents the modulating voltage of the phase-A bridge arm in a case that the frequency-tripling common mode voltage is not injected, Uᵥₘ₁ represents an amplitude of the modulating voltage, and δ₁ represents a phase angle difference between the modulating voltage and the voltage of the power grid.

In a case that the frequency-tripling common mode voltage is injected, the modulating voltage of the phase A is:

$${u}_{aref} = {U}_{vm 1} cos ( ω t + {δ}_{1} ) + {U}_{vm 3} cos ( 3 ω t + {δ}_{3} )$$

where Uᵥₘ₃ represents an amplitude of the injected frequency-tripling common mode voltage, and δ₃ represents a phase angle difference between the frequency-tripling common mode voltage and the voltage of the power grid.

After the frequency-tripling common mode voltage is injected, based on an assumption of dynamic consistency of the direct current bus of the power module of the same bridge arm, the current of the direct current bus thereof can be represented as:

in a case that

$${i}_{dc} = \frac{{I}_{vm 1} {U}_{vm 1}}{2 {NU}_{dc}} [ cos ( {δ}_{1} + {φ}_{1} ) + cos ( 2 ω t + {δ}_{1} - {φ}_{1} ) ] + \frac{{I}_{vm 1} {U}_{vm 3}}{2 {NU}_{dc}} [ cos ( 2 ω t + {δ}_{3} + {φ}_{1} ) + cos ( 4 ω t + {δ}_{3} - {φ}_{1} ) ]$$

$$\{ \begin{matrix}{U}_{vm 3} = {U}_{vm 1} \\ {δ}_{3} = {δ}_{1} - 2 {φ}_{1} \pm π\end{matrix} or \{ \begin{matrix}{U}_{vm 3} = - {U}_{vm 1} \\ {δ}_{3} = {δ}_{1} - 2 {φ}_{1}\end{matrix}$$

is satisfied,
an instantaneous value expression of the current of the direct current bus of the power module is:

$${i}_{dc} = \frac{{I}_{vm 1} {U}_{vm 1}}{2 {NU}_{dc}} [ cos ( {δ}_{1} + {φ}_{1} ) - cos ( 4 ω t + {δ}_{1} - 3 {φ}_{1} ) ]$$

where i_{dc} represents the current of the direct current bus of the power module, N represents the number of power modules contained in the bridge arm per phase, and U_{dc} represents a rated direct current voltage of the battery cluster.

In this case, as far as the single star type connected high voltage direct-mounted energy storage power conversion system is concerned, the frequency-doubling harmonic waves in the current of the direct current bus of the power module thereof are completely inhibited. However, the frequency-quadruplicating harmonic wave current with the equivalent amplitude is increased at the same time, i.e., the frequency-doubling harmonic component in the current of the direct current bus of the power module is improved to quadruplicated frequency.

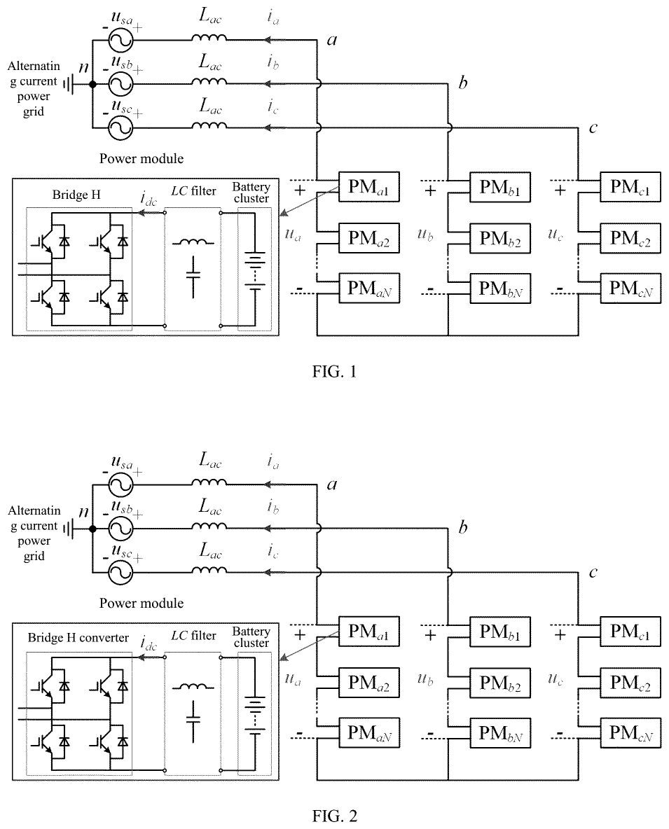

Referring to FIG. 2, it is the schematic diagram of a control structure of the single star type connected high voltage direct-mounted energy storage power conversion system. P_{ref} and Q_{ref} are active and reactive reference values; i_{d} and i_{q} are components of axes d and q of the output current of the three-phase alternating current side; u_{sd} and u_{sq} are components of axes d and q of the three-phase voltage of the power grid; θₚ is the angle of the output of the phase-locked loop; u_{sdref0} and u_{sqref0} are components of axes d and q of the modulating voltage in a case that the frequency-tripling common mode voltage is not injected; u_{xref0} is the modulating voltage of the three-phase bridge arm in a case that the frequency-tripling common mode voltage is not injected; u_{xref} is the modulating voltage of the three-phase bridge arm in a case that the frequency-tripling common mode voltage is injected; and u₃ is the injected frequency-tripling common mode voltage.

For the single star type connected high voltage direct-mounted energy storage power conversion system, complete elimination of the frequency-doubling harmonic wave can be achieved by superposing the set frequency-tripling common mode voltage into the modulating voltage of the bridge arm per phase by the following steps:
(1) first, extracting components i_{d} and i_{q} of axes d and q of an output current of the alternating current side of the power conversion system and components u_{dref0} and u_{qref0} (the output controlled by the current inner loop) of the axes d and q of a modulating voltage thereof, and calculating an amplitude Iᵥₘ₁ of the output current of the alternating current side and an amplitude Uᵥₘ₁ of the modulating voltage of the bridge arm according to the following equations:

$$\{ \begin{matrix}{I}_{vm 1} = \sqrt{{i}_{d}^{2} + {i}_{q}^{2}} \\ {U}_{vm 1} = \sqrt{{u}_{dref 0}^{2} + {u}_{qref 0}^{2}}\end{matrix}$$

(2) second, calculating values of phase angles θ₁ and φ₁, respectively being:

$$\{ \begin{matrix}{δ}_{1} = {tan}^{- 1} ( \frac{{u}_{qref 0}}{{u}_{dref 0}} ) \\ {φ}_{1} = - {tan}^{- 1} ( \frac{{i}_{q}}{{i}_{d}} )\end{matrix}$$

and (3) finally, obtaining the modulating voltage of a three-phase bridge arm:

$$\{ \begin{matrix}{u}_{aref} = {u}_{dref 0} cos ( {θ}_{p} ) - {u}_{qref 0} sin ( {θ}_{p} ) - {U}_{vm 1} cos ( 3 {θ}_{p} + {δ}_{1} - 2 {φ}_{1} ) \\ {u}_{bref} = {u}_{dref 0} cos ( {θ}_{p} - \frac{2}{3} π ) - {u}_{qref 0} sin ( {θ}_{p} - \frac{2}{3} π ) - {U}_{vm 1} cos ( 3 {θ}_{p} + {δ}_{1} - 2 {φ}_{1} ) \\ {u}_{cref} = {u}_{dref 0} cos ( {θ}_{p} + \frac{2}{3} π ) - {u}_{qref 0} sin ( {θ}_{p} + \frac{2}{3} π ) - {U}_{vm 1} cos ( 3 {θ}_{p} + {δ}_{1} - 2 {φ}_{1} )\end{matrix}$$

where u_{xref} represents the modulating voltage of the three-phase bridge arm after the frequency-tripling common mode voltage is injected, subscripts x=a, b, c respectively represent phases A, B, and C, and Op represents an angle of an output of a phase-locked loop.

Referring to FIG. 1, in the single star type connected high voltage direct-mounted energy storage power conversion step, after the frequency-tripling common mode voltage is injected, the modulating voltage thereof can be re-written as:

$${u}_{aref} = {u}_{vm 1} cos ( ω t + {δ}_{1} ) - {U}_{vm 1} cos ( 3 ω t + {δ}_{1} - 2 {φ}_{1} )$$

in a case that φ₁=+π/2 (the system operates in a pure reactive output or input mode), the modulating voltage of the phase-A bridge arm is:

$${u}_{aref} = {U}_{vm 1} cos ( ω t ) + {U}_{vm 1} cos ( 3 ω t )$$

in a case that ωt=0, a maximum value of the amplitude of the modulating voltage of the bridge arm in all working conditions is obtained as follows:

$${( {u}_{aref} )}_{max} = 2 {U}_{vm 1} \approx 2 {U}_{m}$$

for the single star type connected high voltage direct-mounted energy storage power conversion system, the maximum amplitude of the modulating voltage after the frequency-tripling common mode voltage is injected is as twice as the amplitude of the voltage of the power grid.

Referring to FIG. 1, in the single star type connected high voltage direct-mounted energy storage power conversion step, it is assumed that a capacity of a battery cluster of the power module is I_{bat}, (unit: kAh) and in a case that the energy storage power conversion system with a rated capacity of S (unit: MWh) is constructed, a following equation is satisfied:

$${I}_{bat} = \frac{S}{3 {NU}_{dc}}$$

the maximum value of I_{bat} obtained on the market is set as Iₗᵢₘ, if the following equation is satisfied:

$$\frac{S}{3 {NU}_{dc}} \leq {I}_{lim}$$

in a case that the frequency-tripling common mode voltage is injected, the number of power modules contained in the bridge arm per phase is designed as:

$$N = \frac{2 {U}_{m}}{{MU}_{dc}}$$

where M represents a modulating ratio of the power conversion system, the modulating ratio being usually selected as follows: 0.7<M<0.9;
in a case that Iₗᵢₘ satisfies the following equation:

$${I}_{lim} > \frac{S}{3 {NU}_{dc}}$$

the number of power modules contained in the bridge arm per phase is designed as:

$$N = \frac{S}{3 {I}_{lim} {U}_{dc}} .$$

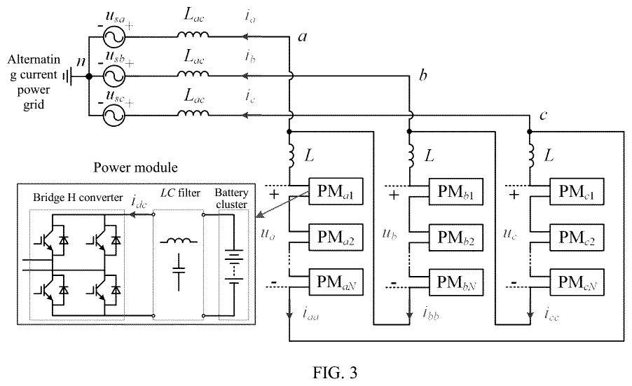

Referring to FIG. 3, it is a schematic diagram of a topological structure of a single angle type high voltage direct-mounted energy storage power conversion system of the present invention;

uₛₓ is a three-phase voltage of a power grid (subscripts x=a, b, c respectively represent phases A, B, and C); L_{ac} is filter inductance of an alternating current side; L is inductance of a three-phase bridge arm; PM_{xy} is a y^{th} cascaded power module of a phase x (y=1, 2 . . . . N); N is a number of power modules contained in the bridge arm per phase; iₓ is an output current of the alternating current side; iₐₓ is a current of the three-phase bridge arm; uₓ is an output voltage of the three-phase bridge arm; i_{dc} is a current of a direct current bus of the power module; and an LC filter in the power module can be L-shaped, T-shaped and π-shaped low pass filter or a harmonic filter formed by connecting an inductor and a capacitor to a harmonic circuit in series and in parallel.

In the single angle type connected high voltage direct-mounted energy storage power conversion step includes: completely eliminating the frequency-doubling harmonic component in the direct current bus current of the power module by injecting the set frequency-tripling common mode current into the modulating voltage of the bridge arm of the converter, obtaining the corresponding frequency-tripling common mode voltage according to the set frequency-tripling common mode current and superposing the required frequency-tripling common mode voltage into the modulating voltage of the bridge arm, specifically as follows:

Referring to FIG. 3, for the single angle type high voltage direct-mounted energy storage power conversion system, the voltage of the power grid of the alternating current side thereof can be written as:

$$\{ \begin{matrix}{u}_{sa} & = {U}_{m} cos ( ω t ) \\ {u}_{sb} & = {U}_{m} cos ( ω t - \frac{2}{3} π ) \\ {u}_{sc} & = {U}_{m} cos ( ω t + \frac{2}{3} π )\end{matrix}$$

where uₛₓ represents a three-phase voltage of the power grid, subscript x=a, b, c respectively represents phases A, B, and C; Uₘ represents an amplitude of the voltage of the power grid; and ω represents an angular frequency of the power grid.

An output current of a three-phase alternating current side thereof is:

$$\{ \begin{matrix}{i}_{a} & = {I}_{vm 1} cos ( ω t - {φ}_{1} ) \\ {i}_{b} & = {I}_{vm 1} cos ( ω t - {φ}_{1} - \frac{2}{3} π ) \\ {i}_{c} & = {I}_{vm 1} cos ( ω t - {φ}_{1} + \frac{2}{3} π )\end{matrix}$$

where iₓ represents the output current of the alternating current side of the power conversions system, subscripts x=a, b, c respectively represent phases A, B, and C, Ivm1 represents an amplitude of the current of the alternating current side, and φ₁ represents a phase angle difference between the output current of the alternating current side and the voltage of the power grid.

Referring to FIG. 3, in a case that the frequency-tripling common mode voltage is not injected, it is assumed that the modulating voltage of the phase-A bridge arm is:

$$\{ \begin{matrix}{u}_{aref 0} & = {U}_{vm 1} cos ( ω t + {δ}_{1} ) \\ {u}_{bref 0} & = {U}_{vm 1} cos ( ω t + {δ}_{1} - \frac{2}{3} π ) \\ {u}_{cref 0} & = {U}_{vm 1} cos ( ω t + {δ}_{1} + \frac{2}{3} π )\end{matrix}$$

where u_{xref0} represents the modulating voltage of the alternating current side in a case that the frequency-tripling common mode voltage is not injected, subscripts x=a, b, c respectively represent phases A, B, and C, Uᵥₘ₁ represents an amplitude of the modulating voltage, and δ₁ represents a phase angle difference between the modulating voltage and the voltage of the power grid.

For the single angle type connected high voltage direct-mounted energy storage power conversion system, in a case that the frequency-tripling common mode current is not injected, the currents flowing into the three-phase bridge arm are respectively:

$$\{ \begin{matrix}{i}_{aa} & = \frac{\sqrt{3}}{3} {I}_{vm 1} cos ( ω t - {φ}_{1} + \frac{5 π}{6} ) \\ {i}_{ab} & = \frac{\sqrt{3}}{3} {I}_{vm 1} cos ( ω t - {φ}_{1} + \frac{π}{6} ) \\ {i}_{ac} & = \frac{\sqrt{3}}{3} {I}_{vm 1} cos ( ω t - {φ}_{1} - \frac{π}{2} )\end{matrix}$$

where iₐₐ, i_{ab}, and i_{ac} respectively represent the currents in the phase-A bridge arm, the phase-B bridge arm, and the phase C bridge arm.

Moreover, in a case that the frequency-tripling common mode current is not injected, the modulating voltage of the three-phase bridge arm can be represented as:

$$\{ \begin{matrix}{u}_{aaref 0} & = \sqrt{3} {U}_{vm 1} cos ( ω t + {δ}_{1} - \frac{π}{6} ) \\ {u}_{abref 0} & = \sqrt{3} {U}_{vm 1} cos ( ω t + {δ}_{1} - \frac{5 π}{6} ) \\ {u}_{acref 0} & = \sqrt{3} {U}_{vm 1} cos ( ω t + {δ}_{1} + \frac{π}{2} )\end{matrix}$$

u_{aaref0}, u_{abref0} and u_{acref0} respectively represent the modulating voltages of the phase-A bridge arm, the phase-B bridge arm, and the phase C bridge arm in a case that the frequency-tripling common mode current is not injected.

Analyzed by taking the phase-A bridge arm as an example, in a case that the frequency-tripling common mode current is injected, the current of the phase-A bridge arm is converted into:

$${i}_{aa} = \frac{\sqrt{3}}{3} {I}_{vm 1} cos ( ω t - {φ}_{1} + \frac{5 π}{6} ) + \frac{\sqrt{3}}{3} {I}_{vm 3} cos ( 3 ω t - {φ}_{3} )$$

where Iᵥₘ₃ represents an amplitude of the injected frequency-tripling common mode current, and δ₃ represents a phase angle difference between the frequency-tripling common mode current and the voltage of the power grid.

After the frequency-tripling common mode current is injected, based on an assumption of dynamic consistency of the direct current bus of the power module of the same bridge arm, the current of the direct current bus thereof can be written as:

$${i}_{dc} = \frac{{U}_{vm 1} {I}_{vm 1}}{2 {NU}_{dc}} [ - cos ( {δ}_{1} + {φ}_{1} ) + cos ( 2 ω t + {δ}_{1} - {φ}_{1} + \frac{2}{3} π ) ] + \frac{{U}_{vm 1} {I}_{vm 3}}{2 {NU}_{dc}} [ cos ( 2 ω t - {δ}_{1} - {φ}_{3} + \frac{π}{6} ) + cos ( 4 ω t + {δ}_{1} - {φ}_{3} - \frac{π}{6} ) ]$$

in a case that

$$\{ \begin{matrix}{I}_{vm 3} & = {I}_{vm 1} \\ {φ}_{3} & = - 2 {δ}_{1} + {φ}_{1} - \frac{1}{2} π \pm π\end{matrix} or \{ \begin{matrix}{I}_{vm 3} & = - {I}_{vm 1} \\ {φ}_{3} & = - 2 {δ}_{1} + {φ}_{1} - \frac{1}{2} π\end{matrix}$$

is satisfied,
an instantaneous value expression of the current of the direct current bus of the power module is:

$${i}_{dc} = \frac{{I}_{vm 1} {U}_{vm 1}}{2 {NU}_{dc}} [ - cos ( {δ}_{1} + {φ}_{1} ) - cos ( 4 ω t + 3 {δ}_{1} - {φ}_{1} + \frac{1}{3} π ) ]$$

where i_{dc} represents the current of the direct current bus of the power module, N represents the number of power modules contained in the bridge arm per phase, and U_{dc} represents a rated voltage of the battery.

In this case, as far as the single angle type connected high voltage direct-mounted energy storage power conversion step shown in FIG. 3 is concerned, the frequency-doubling harmonic waves in the current of the direct current bus of the power module thereof are completely inhibited. However, the frequency-quadruplicating harmonic wave current with the equivalent amplitude is increased at the same time, i.e., the frequency-doubling harmonic component in the current of the direct current bus of the power module is improved to quadruplicated frequency.

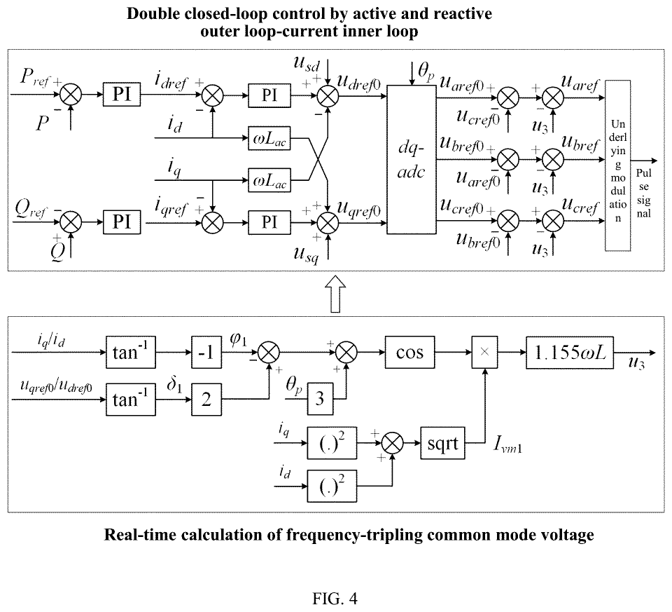

In the single angle type connected high voltage direct-mounted energy storage power conversion step shown in FIG. 3, to eliminate the frequency-doubling harmonic current, the corresponding frequency-tripling common mode voltage is obtained according to the set frequency-tripling common mode current and the set frequency-tripling common mode current is superposed into the modulating voltage of the bridge arm, where the frequency-tripling common mode voltage is obtained by the product of the frequency-tripling common mode current and the reactance of the bridge arm. As shown in FIG. 4, it is the schematic diagram of the control structure of the single angle type connected high voltage direct-mounted energy storage power conversion system (the frequency-tripling common mode current is calculated based on the reactance of the bridge arm). P_{ref} and Q_{ref} are active and reactive reference values; i_{d} and i_{q} are components of axes d and q of the output current of the three-phase alternating current side; u_{sd} and u_{sq} are components of axes d and q of the three-phase voltage of the power grid; Op is the angle of the output of the phase-locked loop; u_{sdref0} and u_{sqref0} are components of axes d and q of the modulating voltage of the alternating current side in a case that the frequency-tripling common mode current is not injected; u_{xref0} is the modulating voltage of the three-phase alternating current side in a case that the frequency-tripling common mode current is not injected; u_{xref} is the modulating voltage of the three-phase bridge arm in a case that the frequency-tripling common mode current is injected; and u₃ is the frequency-tripling modulating voltage needed to inject the frequency-tripling common mode current. An implementation method includes the following steps:
1) extracting the components i_{d} and i_{q} of axes d and q of the output current of the alternating current side of the power conversion system and components u_{dref0} and u_{qref0} of the axes d and q of a modulating voltage thereof (the output controlled by the current inner loop), and calculating the amplitude Iᵥₘ₁ of the output current of the alternating current side according to the following equation:

$${I}_{vm 1} = \sqrt{{i}_{d}^{2} + {i}_{q}^{2}}$$

2) second, calculating values of phase angles δ₁ and φ₁, respectively being:

$$\{ \begin{matrix}{δ}_{1} = {tan}^{- 1} ( \frac{{u}_{qref 0}}{{u}_{dref 0}} ) \\ {φ}_{1} = - {tan}^{- 1} ( \frac{{i}_{q}}{{i}_{d}} )\end{matrix}$$

3) controlling a fundamental frequency component in a current of the phase bridge arm by the fundamental frequency modulating voltage thereof, and obtaining the frequency-tripling component in the current of the phase bridge arm by superposing the frequency-tripling modulating voltage into the fundamental frequency modulating voltage of the phase bridge arm;

calculating the modulating voltage of the three-phase alternating current side by the following equation:

$$\{ \begin{matrix}{u}_{aref 0} = {u}_{dref 0} cos ( {θ}_{p} ) - {u}_{qref 0} sin ( {θ}_{p} ) \\ {u}_{bref 0} = {u}_{dref 0} cos ( {θ}_{p} - \frac{2}{3} π ) - {u}_{qref 0} sin ( {θ}_{p} - \frac{2}{3} π ) \\ {u}_{cref 0} = {u}_{dref 0} cos ( {θ}_{p} + \frac{2}{3} π ) - {u}_{qref 0} sin ( {θ}_{p} + \frac{2}{3} π )\end{matrix}$$

and 4) obtaining the final modulating voltage of the three-phase bridge arm by the following equation:

$$\{ \begin{matrix}{u}_{aaref} = {u}_{aref 0} - {u}_{cref 0} - \frac{2 \sqrt{3}}{3} ω {LI}_{vm 1} cos ( 3 {θ}_{p} + 2 {δ}_{1} - {φ}_{1} ) \\ {u}_{abref} = {u}_{bref 0} - {u}_{aref 0} - \frac{2 \sqrt{3}}{3} ω {LI}_{vm 1} cos ( 3 {θ}_{p} + 2 {δ}_{1} - {φ}_{1} ) \\ {u}_{acref} = {u}_{cref 0} - {u}_{bref 0} - \frac{2 \sqrt{3}}{3} ω {LI}_{vm 1} cos ( 3 {θ}_{p} + 2 {δ}_{1} - {φ}_{1} )\end{matrix}$$

where L is inductance of the phase bridge arm, and θₚ represents an angle of the output of the phase-locked loop.

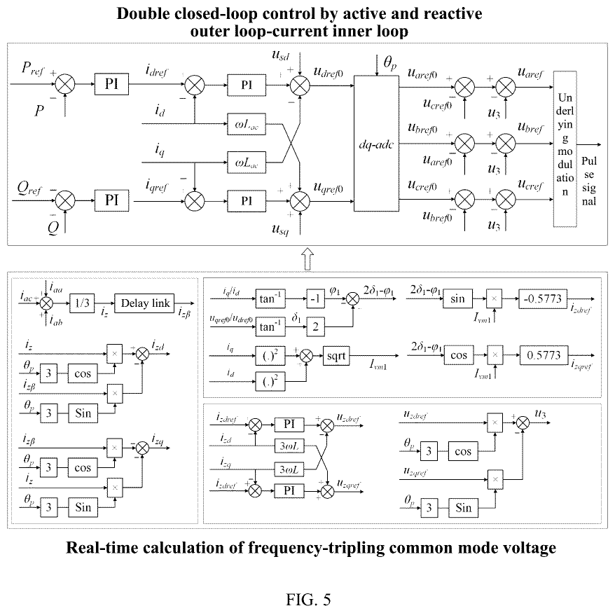

Referring to FIG. 3, in the single angle type connected high voltage direct-mounted energy storage power conversion step, to eliminate the frequency-doubling harmonic current, the corresponding frequency-tripling common mode voltage is obtained according to the set frequency-tripling common mode current and the set frequency-tripling common mode current is superposed into the modulating voltage of the bridge arm. Besides by the product of the frequency-tripling common mode current and the reactance of the bridge arm, the frequency-tripling common mode voltage can further be obtained based on the proportional-integral regulator (PI regulator) and can be further obtained by performing closed-loop control based on the proportional-integral regulator. As shown in FIG. 5, it is the schematic diagram of a control structure of the single star type connected high voltage direct-mounted energy storage power conversion system (the frequency-tripling common mode voltage is calculated based on the PI regulator). P_{ref} and Q_{ref} are active and reactive reference values; i_{d} and i_{q} are components of axes d and q of the output current of the three-phase alternating current side; u_{sd} and u_{sq} are components of axes d and q of the three-phase voltage of the power grid; Op is the angle of the output of the phase-locked loop; u_{sdref0} and u_{sqref0} are components of axes d and q of the modulating voltage of the alternating current side in a case that the frequency-tripling common mode current is not injected; u_{xref0} is the modulating voltage of the three-phase alternating current side in a case that the frequency-tripling common mode current is not injected; u_{xref} is the modulating voltage of the three-phase bridge arm in a case that the frequency-tripling common mode current is injected; and u₃ is the frequency-tripling voltage needed to inject the frequency-tripling common mode current. An implementation method includes the following steps:

(1) extracting current values of three bridge arms in the single angle type connected high voltage direct-mounted energy storage power conversion step shown in FIG. 3, and calculating the frequency-tripling common mode current i_{z} in real time according to the collected current values, a calculation method being as follows: i_{z}=(iₐₐ+i_{ab}+i_{ac})/3, where iₐₐ, i_{ab}, and i_{ac} respectively represent the currents in the phase-A bridge arm, the phase-B bridge arm, and the phase-C bridge arm;
(2) outputting i_{z} by delaying the same at 90°, i.e., delaying T/4 time to obtain i_{zβ}, where i_{zβ} represents a virtual axis β component of the frequency-tripling common mode current obtained by delaying the frequency-tripling common mode current by T/4 time;
(3) calculating components i_{zd} and i_{zq} of axes d and q of a virtual current vector of i_{z} in a synchronous rotating reference frame by the following method:

$$\{ \begin{matrix}{i}_{zd} = {i}_{z} cos ( 3 {θ}_{p} ) - {i}_{z β} sin ( 3 {θ}_{p} ) \\ {i}_{zq} = - {i}_{z β} cos ( 3 {θ}_{p} ) - {i}_{z} sin ( 3 {θ}_{p} )\end{matrix}$$

where θp represents the angle of the output of the phase-locked loop;
(4) extracting the components i_{d} and i_{q} of axes d and q of the output current of the alternating current side of the power conversion system and components u_{dref0} and u_{qref0} of the axes d and q of a modulating voltage thereof (the output controlled by the current inner loop), and calculating the amplitude Iᵥₘ₁ of the output current of the alternating current side according to the following equation:

$${I}_{vm 1} = \sqrt{{i}_{d}^{2} + {i}_{q}^{2}}$$

(5) calculating the values of the phase angles δ₁ and φ₁, respectively being:

$$\{ \begin{matrix}{δ}_{1} = {tan}^{- 1} ( \frac{{u}_{qref 0}}{{u}_{dref 0}} ) \\ {φ}_{1} = - {tan}^{- 1} ( \frac{{i}_{q}}{{i}_{d}} )\end{matrix}$$

(6) performing differential comparison on i_{zd} and i_{zq} and a reference value,

$$\{ \begin{matrix}{i}_{zdref} = - \frac{\sqrt{3}}{3} {I}_{vm 1} sin ( 2 {δ}_{1} - {φ}_{1} ) \\ {i}_{zqref} = \frac{\sqrt{3}}{3} {I}_{vm 1} cos ( 2 {δ}_{1} - {φ}_{1} )\end{matrix}$$

and feeding a difference to a PI regulator;
(7) importing 3ωLi_{zq} and 3ωLi_{zd} on outputs of the respective PI regulators to eliminate a coupled portion of the axes d and q to obtain reference voltages of the axes d and q of the frequency-tripling common mode current, respectively marked as u_{zdref} and u_{zqref},
(8) obtaining the modulating voltage of the three-phase alternating current side by the following equation:

$$\{ \begin{matrix}{u}_{aref 0} = {u}_{dref 0} cos ( {θ}_{p} ) - {u}_{qref 0} sin ( {θ}_{p} ) \\ {u}_{bref 0} = {u}_{dref 0} cos ( {θ}_{p} - \frac{2}{3} π ) - {u}_{qref 0} sin ( {θ}_{p} - \frac{2}{3} π ) \\ {u}_{cref 0} = {u}_{dref 0} cos ( {θ}_{p} + \frac{2}{3} π ) - {u}_{qref 0} sin ( {θ}_{p} + \frac{2}{3} π )\end{matrix}$$

and (9) obtaining the final modulating voltage of the three-phase bridge arm by the following equation:

$$\{ \begin{matrix}{u}_{aaref} = {u}_{aref 0} - {u}_{cref 0} - [ {u}_{zdr ef} cos ( 3 {θ}_{p} ) - {u}_{zqr ef} sin ( 3 {θ}_{p} ) ] \\ {u}_{abref} = {u}_{bref 0} - {u}_{aref 0} - [ {u}_{zdr ef} cos ( 3 {θ}_{p} ) - {u}_{zqr ef} sin ( 3 {θ}_{p} ) ] \\ {u}_{acr ef} = {u}_{cref 0} - {u}_{bref 0} - [ {u}_{zdr ef} cos ( 3 {θ}_{p} ) - {u}_{zqr ef} sin ( 3 {θ}_{p} ) ] .\end{matrix}$$

Referring to FIG. 3, in the single angle type connected high voltage direct-mounted energy storage power conversion step, after the frequency-tripling common mode voltage is injected, the current of the bridge arm of the phase-A bridge arm is:

$${i}_{aa} = \frac{\sqrt{3}}{3} {I}_{vm 1} [ cos ( ω t - {φ}_{1} + \frac{5 π}{6} ) - cos ( 3 ω t + 2 {δ}_{1} - {φ}_{1} + \frac{1}{2} π ) ]$$

in a case that φ₁=±π/2 (the system operates in a pure reactive output or input mode), the current of the bridge arm of the phase-A is:

$${i}_{aa} = \frac{\sqrt{3}}{3} {I}_{vm 1} [ cos ( ω t - {φ}_{1} + \frac{5 π}{6} ) - cos ( 3 ω t + 2 {δ}_{1} - {φ}_{1} + \frac{1}{2} π ) ]$$

in a case that ωt=⅔π, a maximum value of the current of the bridge arm of the phase A in all working conditions is obtained as follows:

$${( {i}_{aa} )}_{max} = \frac{2 \sqrt{3}}{3} {I}_{vm 1}$$

Therefore, for the single angle type connected high voltage direct-mounted energy storage power conversion system, the maximum amplitude of the current of the bridge arm after the frequency-tripling common mode current is injected is 1.15 times of the amplitude of the output current of the alternating current side of the system.

Referring to FIG. 3, for the single angle type connected high voltage direct-mounted energy storage power conversion system, in a case that the energy storage power conversion system with the rated capacity of S (unit: MWh) is constructed, the following equation is satisfied:

$${I}_{vm 1} = \frac{S}{1.5 {U}_{vm 1}}$$

after the frequency-tripling common mode current is injected, in a case that a switching element of the high voltage direct-mounted energy storage power conversion system is subjected to model selection, if a 0.5-1 time of a current margin is considered, a current grade of the switching element shall be selected as follows:

$${I}_{PT} = ( 1.73 \sim 2.31 ) {I}_{vm 1} .$$

where I_{PT} represents current rating of the switching element of the high voltage direct-mounted energy storage power conversion system.

The way of injecting the frequency-tripling common mode electric quantity to eliminate the frequency-doubling harmonic current in the direct current bus of the power module, the frequency-quadruplicating harmonic current component will be imported, and in this case, the imported frequency-quadruplicating harmonic current component can be eliminated by way of injecting a frequency-quintupling common mode electric quantity. In this case, a frequency-hexaplicating harmonic current component will be imported in the direct current bus of the power module, so that the imported frequency-quintupling harmonic current component can be continuously eliminated by way of injecting a frequency-septupling common mode electric quantity. In this case, a frequency-octupling harmonic current component will be imported in the direct current bus of the power module, so that the imported frequency-octupling harmonic current component can be continuously eliminated by way of injecting a frequency-nonupling common mode electric quantity.

The single star type connected high voltage direct-mounted energy storage power conversion step and the single angle type connected high voltage direct-mounted energy storage power conversion step can form a hybrid power conversion system as the basic power conversion units respectively, and then each of the basic power units can eliminate the frequency multiplying current in the direct current bus of each power module by adopting a common mode electric quantity injection method applicable to the unit.

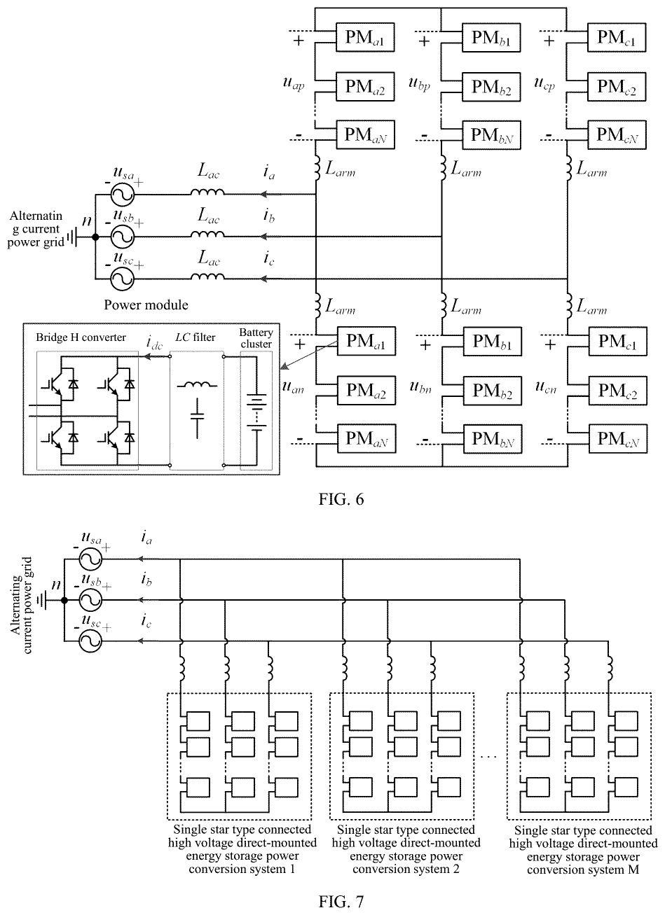

Referring to FIG. 6, for the double star type high voltage direct-mounted energy storage power conversion system, the system is equivalent to a hybrid high voltage direct-mounted energy storage power conversion system formed by connecting two single star type high voltage direct-mounted energy storage power conversion systems on the alternating current side through inductors. In this case, the two single star type high voltage direct-mounted energy storage power conversion systems each can eliminate the secondary harmonic current in the direct current bus of each power module by way of injecting the frequency-tripling common mode voltage, and the principle of injecting the frequency-tripling common mode voltage is the same; similarly, for the double angle type connected high voltage direct-mounted energy storage power conversion systems, in this case, the two single angle type connected high voltage direct-mounted energy storage power conversion systems each can eliminate the secondary harmonic current in the direct current bus of each power module by way of injecting the frequency-tripling common mode current, and the principle of injecting the frequency-tripling common mode current is the same.

Referring to FIG. 7, the hybrid high voltage direct-mounted energy storage power conversion system is formed by connecting M single star type high voltage direct-mounted energy storage power conversion systems on the alternating current side through inductors. In this case, the M single star type connected high voltage direct-mounted energy storage power conversion systems each can eliminate the secondary harmonic current in the direct current bus of each power module by way of injecting the frequency-tripling common mode voltage, and the principle of injecting the frequency-tripling common mode voltage is the same.

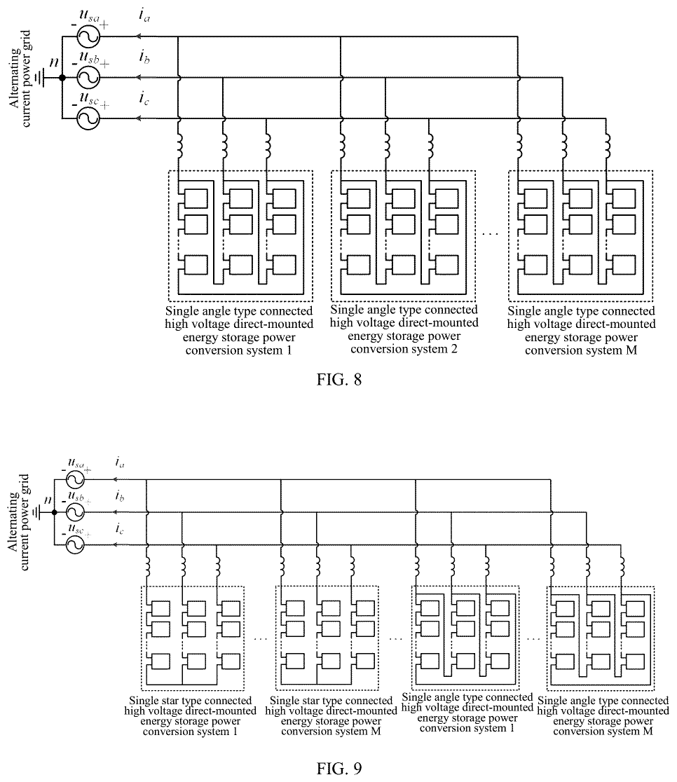

Referring to FIG. 8, the hybrid high voltage direct-mounted energy storage power conversion system is formed by connecting M single angle type connected high voltage direct-mounted energy storage power conversion systems on the alternating current side through inductors. In this case, the M single angle type connected high voltage direct-mounted energy storage power conversion systems each can eliminate the secondary harmonic current in the direct current bus of each power module by way of injecting the frequency-tripling common mode current, and the principle of injecting the frequency-tripling common mode current is the same.

Referring to FIG. 9, the hybrid high voltage direct-mounted energy storage power conversion system is formed by connecting M1 single star type connected high voltage direct-mounted energy storage power conversion systems and M2 single angle type connected high voltage direct-mounted energy storage power conversion systems on the alternating current side through inductors. In this case, the M1 single star type high voltage direct-mounted energy storage power conversion systems each can eliminate the secondary harmonic current in the direct current bus of each power module by way of injecting the frequency-tripling common mode voltage, and the principle of injecting the frequency-tripling common mode voltage is the same; the M2 single angle type connected high voltage direct-mounted energy storage power conversion systems each can eliminate the secondary harmonic current in the direct current bus of each power module by way of injecting the frequency-tripling common mode current, and the principle of injecting the frequency-tripling common mode current is the same.

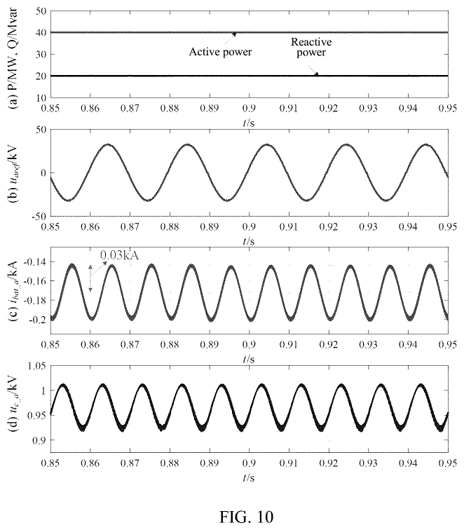

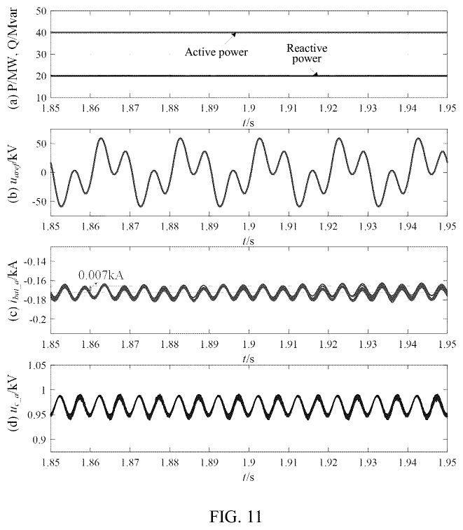

To better verify and explain the technical effect used in the method provided by the present invention, single star type connected and single angle type connected high voltage direct-mounted energy storage power conversion systems are respectively constructed based on PSCAD/EMTDC simulation platforms. For simplicity, the filter in the power module is an L type low pass filter. FIG. 10 and FIG. 11 give a simulation result of the single star type connected high voltage direct-mounted energy storage power conversion system, and simulation parameters are shown in table 1.

TABLE 1
Simulation parameters of single star type connected high voltage
direct-mounted energy storage power conversion system

| Phase voltage Uₘ of power | 28.57 | kV |
|---|---|---|
| Number N of cascaded sub | 80 | |
| Filter inductance L_{ac} of | 20 | mH |
| Filter inductance of direct | 2.5 | mH |
| Filter capacitance of direct | 9 | mF |
| Rated voltage U_{dc} of | 864 | V |
| Capacity I_{bat} of battery | 85 | Ah |
| Control period | 50 | us |

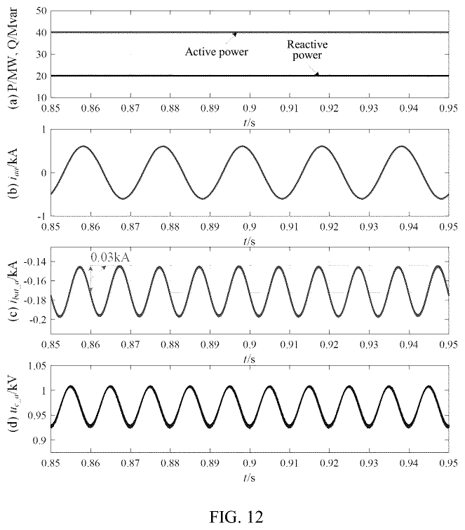

FIG. 12 give a simulation result of the single angle type connected high voltage direct-mounted energy storage power conversion system, and simulation parameters are shown in table 2.

TABLE 2
Simulation parameters of single angle type connected high voltage
direct-mounted energy storage power conversion system

| Phase voltage Uₘ of power | 28.57 | kV |
|---|---|---|
| Number N of cascaded sub | 80 | |
| Filter inductance L_{ac} of | 20 | mH |
| Filter inductance of direct | 2.5 | mH |
| Filter capacitance of direct | 9 | mF |
| Rated voltage U_{dc} of | 864 | V |
| Capacity I_{bat} of battery | 85 | Ah |
| Control period | 50 | us |

FIG. 10 gives a simulation result of the single star type connected high voltage direct-mounted energy storage power conversion system without injecting the frequency-tripling common mode voltage. First to fourth sub diagrams are respectively active and reactive power, modulating voltage of phase A, currents of phase-A battery (10 currents), and voltages of a capacitor of a direct current side of the power module of the phase A (10 voltages). It can be seen that the modulating voltage is a standard sinusoidal wave, the frequency-doubling harmonic current with the amplitude of 0.03 kA flows in the battery, and there is an obvious frequency-doubling pulsation in the voltage of the capacitor of the direct current side.

FIG. 11 gives a simulation result of the single star type connected high voltage direct-mounted energy storage power conversion system in a case that the frequency-tripling common mode voltage is injected. It can be seen that the modulating voltage is no longer the standard sinusoidal wave, the frequency-quadruplicating harmonic current with the amplitude of 0.007 kA only flows in the battery, and moreover, the frequency-doubling fluctuation in the voltage of the capacitor of the direct current side is completely inhibited, and the amplitude of the pulsation voltage is also reduced greatly.

FIG. 12 gives a simulation result of the single angle type connected high voltage direct-mounted energy storage power conversion system without injecting the frequency-tripling common mode current. It can be seen that the modulating voltage of the phase bridge arm is a standard sinusoidal wave, the frequency-doubling harmonic current with the amplitude of 0.03 kA flows in the battery, and there is an obvious frequency-doubling pulsation in the voltage of the capacitor of the direct current side.

In a case that the frequency-tripling common mode current is injected into the single angle type high voltage direct-mounted energy storage power conversion system (the frequency-tripling common mode voltage is calculated based on reactance of the bridge arm), the current of the phase bridge arm is no longer the standard sinusoidal wave, the frequency-doubling component in the current of the battery is completely eliminated, the frequency-quadruplicating harmonic current with the amplitude of 0.007 kA only flows in the battery, and moreover, the frequency-doubling fluctuation in the voltage of the capacitor of the direct current side is completely inhibited, and the amplitude of the pulsation voltage is also reduced greatly.

In a case that the frequency-tripling common mode current is injected into the single angle type high voltage direct-mounted energy storage power conversion system (the frequency-tripling common mode voltage is calculated based on the PI regulator), the current of the phase bridge arm is no longer the standard sinusoidal wave, the frequency-quadruplicating harmonic current with the amplitude of 0.007 kA only flows in the battery till there is no frequency-doubling fluctuation in the voltage of the capacitor of the direct current side, and the amplitude of the voltage pulsation is bettered inhibited.

The embodiments of the present invention provide a high voltage direct-mounted energy storage method and system for eliminating a frequency multiplying current in battery charge and discharge. For the single star type connected high voltage direct-mounted energy storage power conversion system, the harmonic number in the direct current bus current of the power module can be improved from double frequency to quadruplicated frequency by injecting the set frequency-tripling common mode voltage into the modulating voltage of the bridge arm of the converter, which is implemented by directly superposing the set frequency-tripling common mode into the modulating voltage of the bridge arm; and for the single angle type connected high voltage direct-mounted energy storage power conversion system, the harmonic number in the direct current bus current of the power module can be improved from double frequency to quadruplicated frequency by injecting the set frequency-tripling common mode into the bridge arm of the converter, which is implemented by calculating the required frequency-tripling common mode according to the set frequency-tripling common mode and superposing the required frequency-tripling common mode into the modulating voltage of the bridge arm. Moreover, by continuously injecting the frequency-quintupling common mode electric quantity, the frequency-quadruplicating component in the current of the direct current bus of the power module can be improved to higher multiplied frequency till all frequency multiplying currents are completely eliminated. After the harmonic number in the current of the direct current bus of the power module from double frequency to multiplicated frequency, on the one hand, under a condition of the same amplitude of the harmonic current, the requirement of the power module on the passive filter can be reduced greatly, and therefore, the power density of the whole power conversion system is improved. On the other hand, in a case that the same passive filter is used, the amplitude of the harmonic current can be reduced greatly, so that the service life of the battery is prolonged.

Those skilled in the art know that except in form of a pure way of a computer readable program code to implement the system, devices and modules thereof provided by the present invention, the system, devices, modules, and units thereof provided by the present invention can implement the same program in form of a logic gate, a switch, an application-specific integrated circuit, a programmable logic controller, an embedded microcontroller and the like fully by logically programming the method steps. Therefore, the system, devices, modules, and units thereof provided by the present invention are considered a hardware part, and devices, modules, and units for implementing various functions included therein are also considered structures in the hardware part. The devices, modules, and units for implementing various functions can be also considered software programs that implement the method and the structures in the hardware part.

Compared with the prior art, the present invention has the following beneficial effects:
(1) Compared with a conventional method for inhibiting a secondary harmonic current by increasing a passive filter in a power module, the method can eliminate the second harmonic current in the direct bus current of the power module fundamentally to reduce the requirement of a system on a passive filter, which facilitates improvement of a power density of the system;
(2) Compared with a method of additionally arranging a DC/DC bidirectional converter in the power module, extra hardware devices are not needed in the method and the original topological structure is not changed. Therefore, the cost and complexity of the system are reduced integrally, which facilitates improvement of the reliability;
(3) The electric quantity needed in the additional control link can be extracted from the conventional control link of the system without additional hardware devices such as sensors. the mentioned control strategy can implement online real-time control of all working conditions without affecting other functional features of the power conversion system, so that the control link is simple and easy to implement;
(4) the mentioned method is suitable for either the single star or single angle topological structure or a hybrid system formed by the basic power conversion units based on the single star or single angle topological structure, so that the method is high in applicability.

Specific embodiments of the present invention are described above. It is needed to understand that the present invention is not limited to the specific embodiments, and those skilled in the art can made various variations or modifications within the scope of the claims without affecting the substantial contents of the present invention. In the absence of conflict, the embodiments of the application and features in the embodiments can be combined with one another arbitrarily.

What is claimed is:

1. A high voltage direct-mounted energy storage method for eliminating a frequency multiplying current in battery charge and discharge, comprising:
a single star type connected high voltage direct-mounted energy storage power conversion step: injecting a set frequency-tripling common mode voltage into a modulating voltage of a bridge arm of a converter, improving a harmonic number in a direct current bus current of a power module from double frequency to quadruplicated frequency, and directly superposing the set frequency-tripling common mode voltage into the modulating voltage of the bridge arm; and
a single angle type connected high voltage direct-mounted energy storage power conversion step: injecting a set frequency-tripling common mode current into the bridge arm of the converter, improving the harmonic number in the direct current bus current of the power module from the double frequency to the quadruplicated frequency, and calculating a required frequency-tripling common mode voltage according to the set frequency-tripling common mode current and superposing the required frequency-tripling common mode voltage into the modulating voltage of the bridge arm; and
targeted at a harmonic component of an additional frequency-quadruplicating current after a frequency-tripling common mode electric quantity is injected, continuously injecting a corresponding frequency-quintupling common mode electric quantity to improve the corresponding frequency-quintupling common mode electric quantity to a hexaplicating frequency to completely eliminate all frequency-multiplying currents in the direct current bus current of the power module by parity of reasoning.

2. The high voltage direct-mounted energy storage method for eliminating the frequency multiplying current in the battery charge and discharge according to claim 1, wherein the single star type connected high voltage direct-mounted energy storage power conversion step comprises: completely eliminating a frequency-doubling harmonic component in the direct current bus current of the power module by superposing the set frequency-tripling common mode voltage into the modulating voltage of the bridge arm of the converter, wherein
a voltage of a power grid of an alternating current side is:
$$\{ \begin{matrix}{u}_{sa} = {U}_{m} cos ( ω t ) \\ {u}_{sb} = {U}_{m} cos ( ω t - \frac{2}{3} π ) \\ {u}_{sc} = {U}_{m} cos ( ω t + \frac{2}{3} π )\end{matrix}$$
wherein uₛₓ represents a three-phase voltage of the power grid, subscript x=a, b, c respectively represents phases A, B, and C; Uₘ represents an amplitude of the voltage of the power grid; ω represents an angular frequency of the power grid; and t represents time.

3. The high voltage direct-mounted energy storage method for eliminating the frequency multiplying current in the battery charge and discharge according to claim 2, wherein the single star type connected high voltage direct-mounted energy storage power conversion step further comprises:
achieving complete elimination of a frequency-doubling harmonic wave by superposing the set frequency-tripling common mode voltage into the modulating voltage of the bridge arm per phase by the following steps:
first, extracting components i_{d} and i_{q} of axes d and q of an output current of the alternating current side of a power conversion system and components u_{dref0} and u_{qrep0} of the axes d and q of a modulating voltage thereof, and calculating an amplitude Iᵥₘ₁ of the output current of the alternating current side and an amplitude Uᵥₘ₁ of the modulating voltage of the bridge arm according to the following equations:
$$\{ \begin{matrix}{I}_{vm 1} = \sqrt{{i}_{d}^{2} + {i}_{q}^{2}} \\ {U}_{vm 1} = \sqrt{{u}_{dref 0}^{2} + {u}_{qref 0}^{2}}\end{matrix}$$
second, calculating values of phase angles δ₁ and φ₁, respectively being:
$$\{ \begin{matrix}{δ}_{1} = {tan}^{- 1} ( \frac{{u}_{qref 0}}{{u}_{dref 0}} ) \\ {φ}_{1} = - {tan}^{- 1} ( \frac{{i}_{q}}{{i}_{d}} )\end{matrix}$$
finally, obtaining a modulating voltage of a three-phase bridge arm:
$$\{ \begin{matrix}{u}_{aref} = {u}_{dref 0} cos ( {θ}_{p} ) - {u}_{qref 0} sin ( {θ}_{p} ) - {U}_{vm 1} cos ( 3 {θ}_{p} + {δ}_{1} - 2 {φ}_{1} ) \\ \begin{matrix}{u}_{bref} = {u}_{dref 0} cos ( {θ}_{p} - \frac{2}{3} π ) - {u}_{qref 0} sin ( {θ}_{p} - \frac{2}{3} π ) - \\ {U}_{vm 1} cos ( 3 {θ}_{p} + {δ}_{1} - 2 {φ}_{1} )\end{matrix} \\ \begin{matrix}{u}_{cref} = {u}_{dref 0} cos ( {θ}_{p} + \frac{2}{3} π ) - {u}_{qref 0} sin ( {θ}_{p} + \frac{2}{3} π ) - \\ {U}_{vm 1} cos ( 3 {θ}_{p} + {δ}_{1} - 2 {φ}_{1} )\end{matrix}\end{matrix}$$
wherein u_{xref} represents the modulating voltage of the three-phase bridge arm after the set frequency-tripling common mode voltage is injected, subscripts x=a, b, c respectively represent the phases A, B, and C, and θₚ represents an angle of an output of a phase-locked loop.

4. The high voltage direct-mounted energy storage method for eliminating the frequency multiplying current in the battery charge and discharge according to claim 2, wherein in the single star type connected high voltage direct-mounted energy storage power conversion step, after the set frequency-tripling common mode voltage is injected, a modulating voltage U_{aref} of a phase-A bridge arm is re-written as:
$${u}_{aref} = {U}_{vm 1} cos ( ω t + {δ}_{1} ) - {U}_{vm 1} cos ( 3 ω t + {δ}_{1} - 2 {φ}_{1} )$$
wherein φ₁ represents a phase angle difference between an output current of the alternating current side and the voltage of the power grid, Uᵥₘ₁ represents an amplitude of a fundamental frequency modulating voltage of the bridge arm, and δ₁ represents a phase angle difference between the modulating voltage and the voltage of the power grid;
when φ₁=±π/2, the modulating voltage of the phase-A bridge arm is:
$${u}_{aref} = {U}_{vm 1} cos ( ω t ) + {U}_{v m 1} cos ( 3 ω t )$$
when ωt=0, a maximum value of an amplitude of the modulating voltage of the bridge arm in all working conditions is obtained as follows:
$${( {u}_{aref} )}_{m ax} = 2 {U}_{v m 1} \approx 2 {U}_{m}$$
for a single star type connected high voltage direct-mounted energy storage power conversion system, a maximum amplitude of the modulating voltage after the set frequency-tripling common mode voltage is injected is as twice as the amplitude of the voltage of the power grid.

5. The high voltage direct-mounted energy storage method for eliminating the frequency multiplying current in the battery charge and discharge according to claim 4, wherein in the single star type connected high voltage direct-mounted energy storage power conversion step, a capacity of a battery cluster of the power module is set as I_{bat}, and when the single star type connected high voltage direct-mounted energy storage power conversion system with a rated capacity of S is constructed, the following equation is satisfied:
$${I}_{bat} = \frac{S}{3 {NU}_{d c}}$$
wherein U_{dc} represents a rated direct current voltage of the battery cluster, and N represents a number of the power module contained in each bridge arm;
a maximum value of I_{bat} obtained on a market is set as Iₗᵢₘ, if the following equation is satisfied:
$$\frac{S}{3 {NU}_{d c}} \leq {I}_{li m}$$
when the set frequency-tripling common mode voltage is injected, the number of the power module contained in the bridge arm per phase is designed as:
$$N = \frac{2 {U}_{m}}{{MU}_{d c}}$$
wherein M represents a modulating ratio of the single star type connected high voltage direct-mounted energy storage power conversion system, the modulating ratio is selected as follows: 0.7<M<0.9;
when Iₗᵢₘ satisfies the following equation:
$${I}_{li m} > \frac{S}{3 {NU}_{d c}}$$
the number of the power module contained in the bridge arm per phase is designed as:
$$N = \frac{S}{3 {I}_{l im} {U}_{d c}} .$$

6. The high voltage direct-mounted energy storage method for eliminating the frequency multiplying current in the battery charge and discharge according to claim 1, wherein the single angle type connected high voltage direct-mounted energy storage power conversion step comprises: completely eliminating a frequency-doubling harmonic component in the direct current bus current of the power module by injecting the set frequency-tripling common mode current into the bridge arm of the converter, obtaining a corresponding frequency-tripling common mode voltage according to the set frequency-tripling common mode current and superposing the corresponding frequency-tripling common mode voltage into the modulating voltage of the bridge arm, wherein
a voltage of a power grid of an alternating current side is written as:
$$\{ \begin{matrix}{u}_{s a} = {U}_{m} cos ( ω t ) \\ {u}_{s b} = {U}_{m} cos ( ω t - \frac{2}{3} π ) \\ {u}_{s c} = {U}_{m} cos ( ω t + \frac{2}{3} π )\end{matrix}$$
wherein uₛₓ represents a three-phase voltage of the power grid, subscript x=a, b, c respectively represents phases A, B, and C; Uₘ represents an amplitude of the voltage of the power grid; ω represents an angular frequency of the power grid; and t represents time;
an output current of a three-phase alternating current side is:
$$\{ \begin{matrix}{i}_{a} = {I}_{v m 1} cos ( ωt - {φ}_{1} ) \\ {i}_{b} = {I}_{v m 1} cos ( ωt - {φ}_{1} - \frac{2}{3} π ) \\ {i}_{c} = {I}_{v m 1} cos ( ωt - {φ}_{1} + \frac{2}{3} π )\end{matrix}$$
wherein iₓ represents an output current of an alternating current side of a power conversion system, subscripts x=a, b, c respectively represent the phases A, B, and C, Iᵥₘ₁ represents an amplitude of the output current of the alternating current side, and φ₁ represents a phase angle difference between the output current of the alternating current side and the voltage of the power grid.

7. The high voltage direct-mounted energy storage method for eliminating the frequency multiplying current in the battery charge and discharge according to claim 6, wherein in the single angle type connected high voltage direct-mounted energy storage power conversion step, to eliminate a frequency-doubling harmonic current, the corresponding frequency-tripling common mode voltage is obtained according to the set frequency-tripling common mode current and the corresponding frequency-tripling common mode voltage is superposed into the modulating voltage of the bridge arm, wherein the corresponding frequency-tripling common mode voltage is obtained by a product of the set frequency-tripling common mode current and a reactance of the bridge arm, an implementation method comprising the following steps:
first, extracting components i_{d} and i_{q} of axes d and q of the output current of the alternating current side of the power conversion system and components u_{dref0} and u_{qrep0} of the axes d and q of a modulating voltage thereof, and calculating the amplitude Iᵥₘ₁ of the output current of the alternating current side according to the following equation:
$${I}_{vm 1} = \sqrt{{i}_{d}^{2} + {i}_{q}^{2}}$$
second, calculating values of phase angles δ₁ and φ₁, respectively being:
$$\{ \begin{matrix}{δ}_{1} = {tan}^{- 1} ( \frac{{u}_{qref 0}}{{u}_{dref 0}} ) \\ {φ}_{1} = - {tan}^{- 1} ( \frac{{i}_{q}}{{i}_{d}} )\end{matrix}$$
controlling a fundamental frequency component in a current of a phase bridge arm by a fundamental frequency modulating voltage thereof, and obtaining a frequency-tripling component in the current of the phase bridge arm by superposing a frequency-tripling modulating voltage into the fundamental frequency modulating voltage of the phase bridge arm;
calculating a modulating voltage of the three-phase alternating current side by the following equation:
$$\{ \begin{matrix}{u}_{aref 0} = {u}_{dref 0} cos ( {θ}_{p} ) - {u}_{qref 0} sin ( {θ}_{p} ) \\ {u}_{bref 0} = {u}_{dref 0} cos ( {θ}_{p} - \frac{2}{3} π ) - {u}_{qref 0} sin ( {θ}_{p} - \frac{2}{3} π ) \\ {u}_{cref 0} = {u}_{dref 0} cos ( {θ}_{p} + \frac{2}{3} π ) - {u}_{qref 0} sin ( {θ}_{p} + \frac{2}{3} π )\end{matrix}$$
obtaining a final modulating voltage of a three-phase bridge arm by the following equation:
$$\{ \begin{matrix}{u}_{aaref} = {u}_{aref 0} - {u}_{cref 0} - \frac{2 \sqrt{3}}{3} ω {LI}_{vm 1} cos ( 3 {θ}_{p} + 2 {δ}_{1} - {φ}_{1} ) \\ {u}_{ab ref} = {u}_{bref 0} - {u}_{aref 0} - \frac{2 \sqrt{3}}{3} ω {LI}_{vm 1} cos ( 3 {θ}_{p} + 2 {δ}_{1} - {φ}_{1} ) \\ {u}_{acref} = {u}_{cref 0} - {u}_{bref 0} - \frac{2 \sqrt{3}}{3} ω {LI}_{vm 1} cos ( 3 {θ}_{p} + 2 {δ}_{1} - {φ}_{1} )\end{matrix}$$
wherein L is an inductance of the phase bridge arm, and Op represents an angle of an output of a phase-locked loop.

8. The high voltage direct-mounted energy storage method for eliminating the frequency multiplying current in the battery charge and discharge according to claim 6, wherein in the single angle type connected high voltage direct-mounted energy storage power conversion step, to eliminate a frequency-doubling harmonic current, the corresponding frequency-tripling common mode voltage is obtained according to the set frequency-tripling common mode current and the corresponding frequency-tripling common mode voltage is superposed into the modulating voltage of the bridge arm, wherein the corresponding frequency-tripling common mode voltage is further obtained by performing a closed-loop control based on a proportional-integral (PI) regulator, an implementation method comprising the following steps:
1) extracting current values of three bridge arms in the single angle type connected high voltage direct-mounted energy storage power conversion step, and calculating a frequency-tripling common mode current i_{z} in real time according to the collected current values, a calculation method being as follows: i_{z}=(iₐₐ+i_{ab}+i_{ac})/3, wherein iₐₐ, i_{ab}, and i_{ac} respectively represent currents in a phase-A bridge arm, a phase-B bridge arm, and a phase-C bridge arm;
2) outputting i_{z} by delaying i_{z} at 90°, i.e., delaying T/4 time to obtain i_{zβ}, wherein i_{zβ} represents a virtual axis β component of a frequency-tripling common mode current obtained by delaying the frequency-tripling common mode current i_{z} by the T/4 time;
3) calculating components i_{zd} and i_{zq} of axes d and q of a virtual current vector of i_{z} in a synchronous rotating reference frame by the following method:
$$\{ \begin{matrix}{i}_{zd} = {i}_{z} cos ( 3 {θ}_{p} ) - {i}_{z β} sin ( 3 {θ}_{p} ) \\ {i}_{zq} = - {i}_{z β} cos ( 3 {θ}_{p} ) - {i}_{z} sin ( 3 {θ}_{p} )\end{matrix}$$
wherein θp represents an angle of an output of a phase-locked loop;
4) extracting components i_{d} and i_{q} of the axes d and q of the output current of the alternating current side of the power conversion system and components u_{dref0} and u_{qrep0} of the axes d and q of a modulating voltage thereof, and calculating the amplitude Iᵥₘ₁ of the output current of the alternating current side according to the following equation:
$${I}_{vm 1} = \sqrt{{i}_{d}^{2} + {i}_{q}^{2}}$$
5) calculating values of phase angles δ₁ and φ₁, respectively being:
$$\{ \begin{matrix}{δ}_{1} = {tan}^{- 1} ( \frac{{u}_{qref 0}}{{u}_{dref 0}} ) \\ {φ}_{1} = - {tan}^{- 1} ( \frac{{i}_{q}}{{i}_{d}} )\end{matrix}$$
6) performing a differential comparison on i_{zd} and i_{zq} and a reference value,
$$\{ \begin{matrix}{i}_{zdref} = - \frac{\sqrt{3}}{3} {I}_{vm 1} sin ( 2 {δ}_{1} - {φ}_{1} ) \\ {i}_{zqref} = \frac{\sqrt{3}}{3} {I}_{vm 1} cos ( 2 {δ}_{1} - {φ}_{1} )\end{matrix}$$
and feeding a difference to the PI regulator;
7) importing 3ωLi_{zq} and 3ωLi_{zd} on outputs of respective PI regulators to eliminate a coupled portion of the axes d and q to obtain reference voltages of the axes d and q of the frequency-tripling common mode current i_{z}, respectively marked as u_{zdref} and u_{zqref},
8) obtaining a modulating voltage of the three-phase alternating current side by the following equation:
$$\{ \begin{matrix}{u}_{aref 0} = {u}_{dref 0} cos ( {θ}_{p} ) - {u}_{qref 0} sin ( {θ}_{p} ) \\ {u}_{bref 0} = {u}_{dref 0} cos ( {θ}_{p} - \frac{2}{3} π ) - {u}_{qref 0} sin ( {θ}_{p} - \frac{2}{3} π ) \\ {u}_{cref 0} = {u}_{dref 0} cos ( {θ}_{p} + \frac{2}{3} π ) - {u}_{qref 0} sin ( {θ}_{p} + \frac{2}{3} π )\end{matrix}$$
and 9) obtaining a final modulating voltage of a three-phase bridge arm by the following equation:
$$\{ \begin{matrix}{u}_{aaref} = {u}_{aref 0} - {u}_{cref 0} - [ {u}_{zdref} cos ( 3 {θ}_{p} ) - {u}_{zqref} sin ( 3 {θ}_{p} ) ] \\ {u}_{abref} = {u}_{bref 0} - {u}_{aref 0} - [ {u}_{zdref} cos ( 3 {θ}_{p} ) - {u}_{zq ref} sin ( 3 {θ}_{p} ) ] \\ {u}_{acref} = {u}_{cref 0} - {u}_{bref 0} - [ {u}_{zdref} cos ( 3 {θ}_{p} ) - {u}_{zqref} sin ( 3 {θ}_{p} ) ] .\end{matrix}$$

9. The high voltage direct-mounted energy storage method for eliminating the frequency multiplying current in the battery charge and discharge according to claim 6, wherein in the single angle type connected high voltage direct-mounted energy storage power conversion step, after the set frequency-tripling common mode voltage is injected, a current of a phase-A bridge arm is:
$${i}_{aa} = \frac{\sqrt{3}}{3} {I}_{vm 1} [ cos ( ω t - {φ}_{1} + \frac{5 π}{6} ) - cos ( 3 ω t + 2 {δ}_{1} - {φ}_{1} + \frac{1}{2} π ) ]$$
when φ₁=±π/2, the current of the phase-A bridge arm is:
$${i}_{aa} = \frac{\sqrt{3}}{3} {I}_{vm 1} [ cos ( ω t - {φ}_{1} + \frac{5 π}{6} ) - cos ( 3 ω t + 2 {δ}_{1} - {φ}_{1} + \frac{1}{2} π ) ]$$
when ωt=⅔π, a maximum value of the current of the phase-A bridge arm in all working conditions is obtained as follows:
$${( {i}_{aa} )}_{max} = \frac{2 \sqrt{3}}{3} {I}_{vm 1}$$
for a single angle type connected high voltage direct-mounted energy storage power conversion system, a maximum amplitude of the current of the bridge arm after the set frequency-tripling common mode current is injected is 1.15 times of the amplitude of the output current of the alternating current side of the system;
for the single angle type connected high voltage direct-mounted energy storage power conversion step, when a single angle type connected high voltage direct-mounted energy storage power conversion system with a rated capacity of S is constructed, the following equation is satisfied:
$${I}_{vm 1} = \frac{S}{1.5 {U}_{vm 1}}$$
after the set frequency-tripling common mode current is injected, when a switching element of the single angle type connected high voltage direct-mounted energy storage power conversion system is subjected to a model selection, if a 0.5-1 time of a current margin is considered, a current grade of the switching element is selected as follows:
$${I}_{PT} = ( 1.73 ∼ 2.31 ) {I}_{vm 1}$$
wherein I_{PT} represents a current rating of the switching element of the single angle type connected high voltage direct-mounted energy storage power conversion system.

10. A high voltage direct-mounted energy storage system for eliminating a frequency multiplying current in battery charge and discharge, comprising:
a single star type connected high voltage direct-mounted energy storage power conversion module, configured to inject a set frequency-tripling common mode voltage into a modulating voltage of a bridge arm of a converter, improve a harmonic number in a direct current bus current of a power module from double frequency to quadruplicated frequency, and directly superpose the set frequency-tripling common mode voltage into the modulating voltage of the bridge arm; and
a single angle type connected high voltage direct-mounted energy storage power conversion module, configured to inject a set frequency-tripling common mode current into the bridge arm of the converter, improve the harmonic number in the direct current bus current of the power module from the double frequency to the quadruplicated frequency, calculate a required frequency-tripling common mode voltage according to the set frequency-tripling common mode current and superpose the required frequency-tripling common mode voltage into the modulating voltage of the bridge arm; and
targeted at a harmonic component of an additional frequency-quadruplicating current after a frequency-tripling common mode electric quantity is injected, continuously inject a corresponding frequency-quintupling common mode electric quantity to improve the corresponding frequency-quintupling common mode electric quantity to a hexaplicating frequency to completely eliminate all frequency-multiplying currents in the direct current bus current of the power module by parity of reasoning.
